(19) United States
(12) Patent Application Publication
(10) Pub. No.: US 2026/0281242 A1
(43) Pub. Date: Sep. 17, 2026

(54) EVENT CLUSTER

(71) Applicant: Intrado Life & Safety, Inc., Longmont, CO (US)

(72) Inventors: Andrea M. Lewis, Capitola, CO (US); Michel Brkovic, St-Eustache (CA)

(21) Appl. No.: 19/076,447

(22) Filed: Mar. 11, 2025

(51) Int. Cl. H04M 3/51; H04M 3/523; H04M 3/527

(52) U.S. Cl. CPC H04M 3/5116; H04M 3/523; H04M 3/527

(57) ABSTRACT

Particular example embodiments described herein can provide for a system, an apparatus, and a method to help enable the creation of an event cluster. In an example, the system, apparatus, and method can receive a communication related to an event from an electronic device, create a cluster for the event if the cluster for the event has not already been created, where the cluster is associated with a specific public safety answering point (PSAP) operator at a PSAP, add the communication to the cluster, and send the communication to the specific PSAP operator.

### TECHNICAL FIELD

This disclosure relates in general to the field of computing and/or networking and, more particularly, to a system, an apparatus, and a method to help enable the creation of an event cluster.

### BACKGROUND

A public-safety answering point (PSAP), sometimes called a public-safety access point, is a call center where emergency/non-emergency calls (like police, fire brigade, ambulance) are received and handled. The PSAP is a call center in almost all the countries, including Canada and the United States, where a trained PSAP operator is typically responsible for answering calls to an emergency telephone number for police, firefighting, and ambulance services. Some PSAPs have the ability to receive and respond to text messages.

In Canada and the United States, counties are generally bound to provide a PSAP and other emergency services even within municipalities, unless the municipality chooses to opt out and have its own system. Each PSAP has a ‘real’ telephone number that is called when an emergency number (e.g., 911) is dialed or texted. The telecommunications operator is responsible for associating all landline numbers with the most applicable (often the nearest) PSAP, such that when the emergency number is dialed, the call or text is automatically routed to the most suitable PSAP.

Internet of things (IoT) devices are self-reporting devices that can connect to other devices and systems over a network (e.g., Internet) to exchange data. IoT devices are programmed for specific applications and can be embedded into other devices, such as appliances, gadgets, machines, or sensors. IoT devices have at least one sensor or actuator to interact with the physical world and at least one network interface, such as Bluetooth, Wi-Fi, or Ethernet, to connect with the digital world. IoT devices are not limited to computers or machinery and can include anything with a sensor that is assigned a unique identifier (UID). Some IoT devices have the capability to communicate information to a public-safety answering point (PSAP) or PSAP related device.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1A is a simplified block diagram of a system to help enable the creation of an event cluster, in accordance with an embodiment of the present disclosure;

FIG. 1B is a simplified block diagram of a system to help enable the creation of an event cluster, in accordance with an embodiment of the present disclosure;

FIG. 2 is a simplified block diagram of a particular implementation of a cluster engine to help enable the creation of an event cluster, in accordance with an embodiment of the present disclosure;

FIG. 3 is a simplified block diagram illustrating examples details of a particular implementation of a system to help enable the creation of an event cluster, in accordance with an embodiment of the present disclosure;

FIG. 4 is a simplified block diagram illustrating examples details of a particular implementation of a system to help enable the creation of an event cluster, in accordance with an embodiment of the present disclosure;

FIG. 5 is a simplified block diagram illustrating examples details of a particular implementation of a system to help enable the creation of an event cluster, in accordance with an embodiment of the present disclosure;

FIG. 6 is a simplified block diagram illustrating examples details of a particular implementation of a system to help enable the creation of an event cluster, in accordance with an embodiment of the present disclosure;

FIGS. 7A-7D are simplified block diagrams illustrating examples details of a particular implementation of a user interface of a system to help enable the creation of an event cluster, in accordance with an embodiment of the present disclosure;

FIG. 8 is a simplified flowchart illustrating potential operations to help enable the creation of an event cluster, in accordance with an embodiment of the present disclosure;

FIG. 9 is a simplified flowchart illustrating potential operations to help enable the creation of an event cluster, in accordance with an embodiment of the present disclosure;

FIG. 10 is a simplified flowchart illustrating potential operations to help enable the creation of an event cluster, in accordance with an embodiment of the present disclosure;

FIG. 11 is a simplified flowchart illustrating potential operations to help enable the creation of an event cluster, in accordance with an embodiment of the present disclosure;

FIG. 12 is a simplified flowchart illustrating potential operations to help enable the creation of an event cluster, in accordance with an embodiment of the present disclosure;

FIG. 13 is a simplified flowchart illustrating potential operations to help enable the creation of an event cluster, in accordance with an embodiment of the present disclosure;

FIG. 14 is a simplified block diagram illustrating example details of an example computer model inference and computer model training to help enable the creation of an event cluster, in accordance with an embodiment of the present disclosure; and

FIG. 15 is a simplified block diagram illustrating examples details of an example neural network architecture to enable the creation of an event cluster, in accordance with an embodiment of the present disclosure.

The FIGURES of the drawings are not necessarily drawn to scale, as their dimensions can be varied without departing from the scope of the present disclosure.

### DETAILED DESCRIPTION

The following detailed description sets forth examples of apparatuses, methods, and systems relating to the creation of an event cluster, in accordance with an embodiment of the present disclosure. Features such as structure(s), function(s), and/or characteristic(s), for example, are described with reference to one embodiment as a matter of convenience; various embodiments may be implemented with any suitable one or more of the described features.

### Overview

A public-safety answering point (PSAP) can receive multiple communications from voice call, text, and IoT devices. Currently, when a communication is received by a PSAP, the communication is put into a queue and then assigned to a next available PSAP operator. However, as different types of communications are received by the PSAP, each type of communication is received differently and will often be put into different queues. Also, sometimes multiple communications will be received about the same event and some of the communications about the same event may be sent to different PSAP operators that have no prior knowledge about the event.

In an example, a cluster engine can be configured to analyze communications sent to a PSAP and determine if a cluster should be created for an event. In some examples, the cluster engine uses a computer model or machine learning to identify an event associated with the communication and determine if a cluster should be created for the event or if the communication should be added to an already existing cluster. The cluster is created to allow communications related to the event to be sent to a single PSAP operator that is familiar with the event. By sending all the communications related to an event to a single PSAP operator, the PSAP operator can gain a more complete picture of the event and, if the event is an emergency event or a potential emergency event, the PSAP operator can dispatch emergency services to the emergency event or potential emergency event. In some examples, if the event is a major disaster or shooting where a command center is established, communications related to the same major disaster or shooting can be sent to the command center.

By combining communications related to the same event in a cluster and sending all the communications in the cluster to a specific PSAP operator, the specific PSAP operator can gain a more complete picture of the event, including its scope, severity, and evolving nature. Using clusters can reduce response times for an event beyond a simple voice call to 911 and can provide for a more accurate response to the event by the PSAP, ultimately resulting in better outcomes for those in an emergency situation. In some examples, when a cluster is created, an auto message is also created and the auto message is sent to a user in response to the user sending a communication regarding the event in the cluster. The auto message helps to inform the originator of the communication that the subject event of the communication is known to the PSAP operator and the PSAP is addressing the subject of the event. In some examples, when a communication is received at a PSAP, the communication is sent to a common queue that includes all the communication received by the PSAP.

### Example Systems, Apparatuses, and Methods

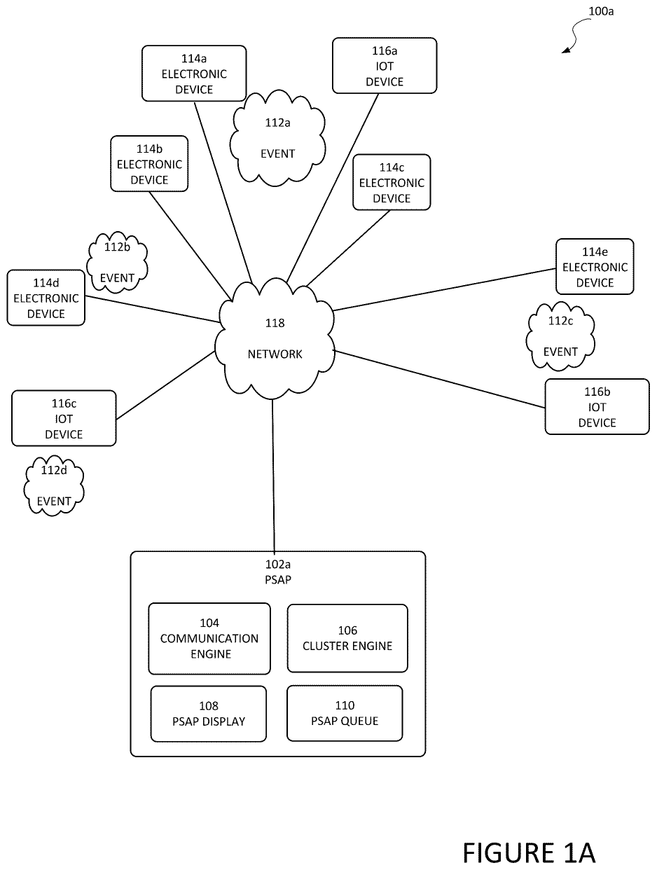

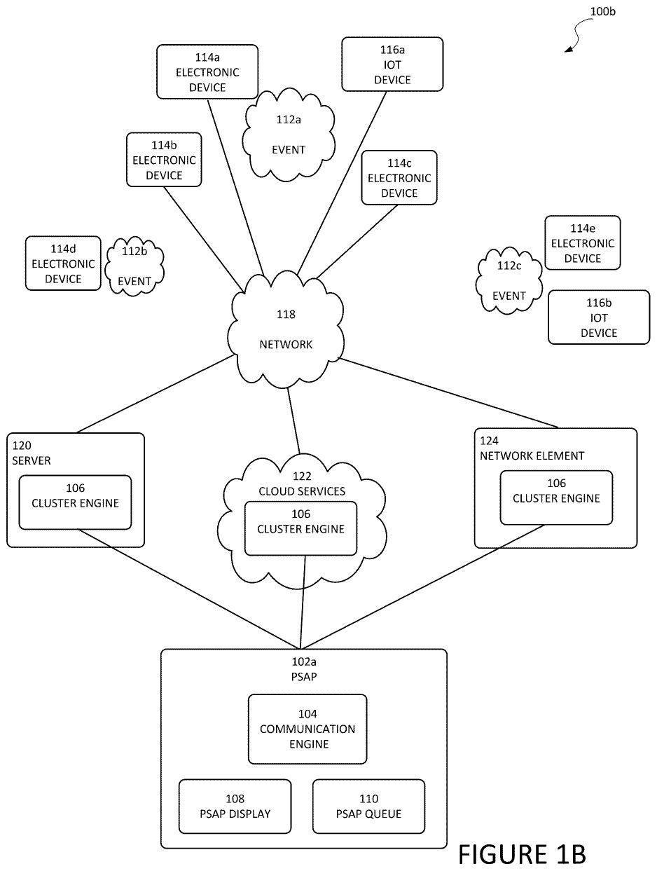

FIG. 1A is simplified block diagram of a particular non-limiting system 100a to enable the creation of an event cluster. An event cluster is a grouping of communications related to the same event. For example, communications related to a vehicle accident can be grouped together as an event (the vehicle accident) cluster. The system 100a can include a PSAP 102. The PSAP 102 can include a communication engine 104, a cluster engine 106, a PSAP display 108, and a PSAP queue 110.

The communication engine 104 can be configured to help to facilitate communications to and from the PSAP 102. The cluster engine 106 can be configured to help cluster communications. In some examples, the cluster engine 106 can include a large language model, computer model and/or machine learning to help cluster communications. The PSAP display 108 can be configured to display information to a PSAP operator. The PSAP queue 110 stores received communications to the PSAP 102 until the communications can be sent to a PSAP operator.

In an illustrative example, one or more events 112 can occur. Each event 112 can be an event that may be an emergency event where emergency services need to be routed or are being routed to the event (e.g., a major vehicle accident, public shooting, fire, earthquake, etc.), an event where a PSAP operator may monitor the event to determine if emergency services need to be routed to the event (e.g., a minor vehicle accident that may cause additional vehicle accidents, a public disturbance that may escalate, noxious smell, etc.), or an event that does not require emergency services (e.g., a wild animal citing, nuisance call that is not related to PSAP services (e.g., late food service), etc.).

One or more electronic devices 114 and or IoT devices 116 may communicate details about a specific event 112 to the PSAP 102 using network 118. For example, as illustrated in FIG. 1A, an event 112a occurred, an event 112b occurred, an event 112c occurred, and an event 112d occurred. Electronic devices 114a, 114b, and 114c and IoT device 116a may communicate details about the event 112a to the PSAP 102 using network 118. Electronic device 114d may communicate details about the event 112b to the PSAP 102 using network 118. Electronic device 114e and IoT device 116b may communicate details about the event 112c to the PSAP 102 using network 118. IoT device 116c may communicate details about the event 112d to the PSAP 102 using network 118.

As each communication from the electronic devices 114 and IoT devices 116 are received at the PSAP 102, they are analyzed by the cluster engine 106 to determine if one or more communications are related to the same event. For example, the communications from the electronic devices 114a, 114b, and 114c and the IoT device 116a can be determined to be about the same event 112a and the communications from the electronic devices 114a, 114b, and 114c and the IoT device 116a can be clustered together and sent to the same PSAP operator. In current systems that do not include the cluster engine 106, each of the communications from the electronic devices 114a, 114b, and 114c and the IoT device 116a may be sent to a different PSAP operator and each of the different PSAP operators may not know about the other communications about the event 112a. By sending the communications related to the same event to a specific PSAP operator, the specific PSAP operator is familiar with the event and can more quickly respond to the event as compared to a PSAP operator that is not familiar with the event and might need to gather more information before responding to the event.

Turning to FIG. 1B, FIG. 1B is simplified block diagram of a particular non-limiting system 100b to enable the creation of an event cluster. The system 100b can include a PSAP 102b, one or more servers 120, cloud services 122, and/or one or more network elements 124. The PSAP 102 can include the communication engine 104, the PSAP display 108, and the PSAP queue 110. One or more of the servers 120, cloud services 122 and/or network elements 124 can include the cluster engine 106.

Similar to FIG. 1A, the one or more electronic devices 114 and or IoT devices 116 may communicate details about a specific event 112 to the PSAP 102 using network 118. For example, as illustrated in FIG. 1B, the event 112a occurred and electronic devices 114a, 114b, and 114c and IoT device 116a may communicate details about the event 112a to the PSAP 102 using network 118. The event 112b occurred and electronic device 114d may communicate details about the event 112b to the PSAP 102 using network 118. The event 112c occurred and electronic device 114e and IoT device 116c may communicate details about the event 112c to the PSAP 102 using network 118.

Before being received by the PSAP 102 each communication from the electronic devices 114 and IoT devices 116 is analyzed by the cluster engine 106 in the one or more the servers 120, cloud services 122 and/or network elements 124 to determine if one or more communications are related to the same event. For example, the communications from the electronic devices 114a, 114b, and 114c and the IoT device 116a can be determined to be about the same event 112a and the communications from the electronic devices 114a, 114b, and 114c and the IoT device 116a can be clustered together and sent to a specific PSAP operator. In current systems that do not include the cluster engine 106, each of the communications from the electronic devices 114a, 114b, and 114c and the IoT device 116a may be sent to a different PSAP operator and each of the different PSAP operators may not know about the other communications about the event 112a. By sending the communications related to the same event to a specific PSAP operator, the specific PSAP operator is familiar with the event and can more quickly respond to the event as compared to a PSAP operator that is not familiar with the event and might need to gather more information before responding to the event.

In some examples, when a cluster for an event is created, the cluster engine can be configured to create an auto message that is used when a communication about the event is received. The auto message can be automatically activated or a PSAP operator can activate an auto message suggested by the cluster engine 106. When the cluster engine 106 determines that a communication belongs in a previously created cluster, the cluster engine 106 can send the auto message in response to the communication. The auto message can provide an automatic response to the user that originated the communication, for example, “Thank you for your call or text. If you are calling or texting about the vehicle accident on I-35 near the I-820 exit, help has been dispatched. If you are not calling or texting about the vehicle accident on I-35 near the I-820 exit or have information you would like to share about the vehicle accident on I-35 near the I-820 exit, please press pound one on your device.” The prompt pound one is a prompt that can be offered for the user that originated the communication to be connected to an emergency PSAP operator in case the communication is not about the event or includes additional information related to the event (e.g., in the case of a hit and run, a user may know the license plate of the vehicle that left the scene). The prompt can be a request to push buttons “#” and “1” on a device, a voice prompt, or some other type of action that can allow the user that sent the communication to be routed to a PSAP operator.

It is to be understood that other embodiments and implementations may be utilized, and structural changes may be made without departing from the scope of the present disclosure. Substantial flexibility is provided by the system and method in that any suitable arrangements and configuration may be provided without departing from the teachings of the present disclosure. For purposes of illustrating certain example techniques to enable the creation of an event cluster, the following foundational information may be viewed as a basis from which the present disclosure may be properly explained. A number of prominent technological trends are currently afoot (e.g., more mobile computing devices, more mobile services, more Internet traffic), and these trends are changing the media delivery landscape. One trend is the ability to communicate using a portable wireless device such as a cell phone or smart phone. These portable wireless devices allow user to easily communicate with others, especially with a PSAP regarding an emergency event. Another trend is the ability to communicate with a PSAP using text messaging. Text-to-911 is the ability to send a text message to reach 911 emergency call takers from a mobile phone or text enabled device. Yet another trend is the proliferation of IoT devices.

IoT devices are devices that can connect to other devices and systems over the Internet to exchange data. IoT devices can include consumer IoT devices, industrial IoT devices, vehicle IoT devices, commercial IoT devices, and other IoT devices. The growing wave of IoT devices, from smartphones to home security systems, has created an influx of data that could help first responders save lives. For example, IoT devices can track mobile locations in real-time, smart thermometers can detect temperature changes during fires, security systems can simultaneously detect movement and share live video feeds, IoT devices in vehicles can detect conditions before, during, and after a vehicle accident. These real-time data streams can make a huge impact on an emergency response system. With portable wireless devices allowing users to easily communicate with a PSAP regarding an emergency event, the ability to communicate with a PSAP using text messaging, and the proliferation of IoT devices, a PSAP can receive multiple communications and multiple different types of communications in a relative short amount of time.

The PSAP, sometimes called a public-safety access point, is a call center where emergency/non-emergency calls (like police, fire brigade, ambulance) are received. When a communication is sent to a PSAP, a highly trained professional human PSAP operator is expected to respond to the communication. However, PSAP operators are part of an industry under immense pressure because of understaffing and a host of other issues. PSAP centers are struggling with surging call and text volumes, complex compounded emergencies, outdated technologies, and insufficient support. Because operators at the PSAPs need to handle each call and text, calls and text to the PSAP that are related to the same emergency event and do not provide any additional details about the emergency event waste precious time of the PSAP operators and prevent the PSAP operators from handling other emergencies. This adds to the stress the PSAP operators face every day and is another deterrent to employee retention.

Also, when a PSAP operator answers an emergency call, they are tasked with acquiring as much information as possible from the caller, including the location and nature of the event. PSAP call-takers frequently receive incomplete or inaccurate descriptions of an event from callers who are confused, in distress, or unable to verbally communicate. Often, callers can be panicked, injured or otherwise unable to reliably articulate the information the PSAP operator needs to dispatch the appropriate type and amount of first responders to the event and/or provide the dispatched first responders with an accurate description of the event. In addition, acquiring the information takes time, and during an emergency event, every second counts. What is needed is a system, an apparatus, and a method to help route communications related to a known emergency event in a way that that allows the PSAP operator(s) to focus their attention on the communications that need the PSAP operator's attention.

A system, method, apparatus, means, etc. to help enable the creation of an event cluster can help resolve these issues (and others). In an example, a system, method, apparatus, means, etc. can include a cluster engine (e.g., the cluster engine 106). The cluster engine can receive communications from multiple devices and multiple different types of devices and can use the data to cluster together communications that are related to a same event. In some examples, the cluster engine uses a large language model, computer model and/or machine learning to cluster communications.

A PSAP can receive multiple communications from voice call, text, and IoT devices. Currently, when a communication is received by a PSAP, the communication is put into a queue and then assigned to an available PSAP operator. However, as different types of communications are received by the PSAP, each type of communication is received differently and will often be put into different queues. Also, sometimes multiple communications will be received about the same event and some of the communications about the same event may be sent to different PSAP operators that have no prior knowledge about the event. By consolidating multiple related communications into a single event cluster and sending the multiple related communications to a specific PSAP operator, the system can provide the specific PSAP operator with a more comprehensive understanding of an event. This enhanced situational awareness helps to enable more informed decisions regarding resource allocation and can lead to improved response times and outcomes.

In some examples, the cluster engine can be configured to identify potential event clusters by analyzing Incoming communications for specific keywords and patterns. These keywords, often associated with large-scale emergencies, can trigger the creation of an event cluster. Examples of large-scale emergencies can include, natural disasters (e.g., earthquake, flood, tornado, hurricane, wildfire, etc.), accidents (e.g., multi-vehicle accidents, multi-vehicle pile-up, train wreck, plane crash, etc.), active threats (e.g., active shooter, bomb threat, hostage situation, etc.), infrastructure failures (e.g., power outage, water main break, bridge collapse, etc.) and other large scale emergency events. By monitoring for these keywords, the cluster engine can quickly determine if multiple communications are likely connected to a single emergency event.

In some examples, the cluster engine can use a large language model, computer model and/or machine learning to identify patterns and correlations between reported events and cluster communications related to the same event. More specifically, in one example, the cluster engine can use natural language processing (NLP) to analyzes communications for keywords, sentiment, and patterns. In some examples, the cluster engine can use clustering algorithms to group similar communications based on features like location, time, and content. In addition, geographical information systems (GIS) can analyze geographic data to identify clusters of events and proximity relationships. Temporal analysis may be used to analyze the time patterns of communications to identify related events occurring within a short timeframe. Knowledge Graphs may also be used to construct knowledge graphs to represent relationships between entities and infer connections between events.

Once the cluster engine determines that multiple communications are likely related to a single event, an event cluster for the event is created. The event cluster serves as a central repository for all relevant information about the incident, providing PSAP operators with a comprehensive overview of the event and facilitating coordinated response efforts. By consolidating information from multiple sources, PSAP operators gain a more complete picture of the incident, including its scope, severity, and evolving nature. This comprehensive understanding can help enable more informed decisions regarding the deployment of emergency services and help ensure that resources are allocated effectively and efficiently.

In some examples, all communications to a PSAP are sent to a single queue while waiting to be assigned to a PSAP operator instead of being sent to multiple queues. PSAPs want additional data relevant to an event to help determine if the event is an emergency event and what type of emergency response is needed. PSAP hardware and software vary by country, state, region, county, city, and even sometimes by response jurisdictions within a city. To make matters more confusing, often there is overlap in jurisdictions. This means that every PSAP for the most part (over 6,000 across North America) may have different hardware and software combinations, and even different versions based on a specific PSAP's protocols, policies, and procedures. In addition, network security and internet access varies greatly from one PSAP to the next. It is for this reason that PSAPs want to receive additional information about an emergency call via their existing systems within existing workflows and call queues. There is also a quickly growing trend to receive fewer voice calls and more requests for assistance via other means such as data messages to 911, text messages to 911, or direct integration into a computer-aided dispatch system. Integrating the data from IoT devices into the 911 communication workflow is beneficial for public safety and can help PSAP operators detect an emergency event or a potential emergency event and the type of response needed for the emergency event or potential emergency event. By sending all communications to a PSAP to a single queue, all the communications and data relevant to an event is located in one queue to help the system determine if multiple communications are related to the same event.

In an illustrative example of a vehicle accident, sensors in the vehicles are capable of communicating the location of a vehicle, whether or not the vehicle is overturned or on fire, how many occupants are in the vehicle, the speed upon impact, how many airbags were deployed and which ones, along with other data. Delivering this information to a PSAP operator can make the difference in how quickly an emergency event can be identified and the type and number of responders that are dispatched to the emergency event. For example, if there was a vehicle accident where the vehicle has rolled over, caught fire, and the doors of the vehicle will not open, the Jaws of Life may be needed immediately. Several valuable minutes may be lost while waiting for an on-scene decision as the first responders arrive, assess the situation and call for the Jaws of Life. By sending communications related to the same event vehicle accident to a specific PSAP operator, the PSAP operator can determine the severity of the accident, that an occupant of the vehicle is trapped, and the PSAP operator can dispatch the Jaws of Life when dispatching the first responders.

Integrating IoT devices offer opportunities to improve PSAP capabilities. For examples, one or more IoT devices across a city may detect a major event and communications from the IoT devices can be relayed to a specific PSAP operator, ensuring quick and informed response efforts. The specific PSAP operator can use information feeds from the IoT devices (e.g., cameras, carbon monoxide detectors, heat sensors, fire alarms) and other communications (e.g., calls, texts, etc.) to help the specific PSAP operator make rapid decisions on the type of response needed for the specific emergency event. This data can be aggregated, analyzed and turned into actionable information such as situational communications, then pushed out to first responders in route to support decision-making and help mitigate risk. In addition, further data intelligence could be gathered by IoT devices such as cameras on responders who are at the scene, which can provide PSAP operators and/or commanders with an enhanced, near real time view, as well as a useful data source for post-incident reports.

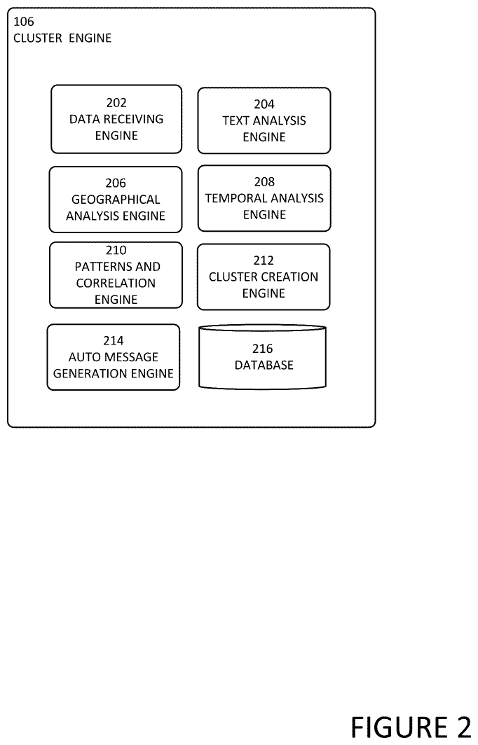

Turning to FIG. 2, FIG. 2 is a simplified block diagram illustrating example details of a particular non-limiting illustrative example of the cluster engine 106. As illustrated in FIG. 2, the cluster engine 106 can include a data receiving engine 202, a text analysis engine 204, a geographical analysis engine 206, a temporal analysis engine 208, a patterns and correlation engine 210, a cluster creation engine 212, an auto message generation engine 214, and a database 216. The data receiving engine 202 is configured to received data from one or more PSAP queues and/or one or more electronic devices, IoT devices, and other devices that send data to a PSAP. In some examples, the data receiving engine 202 can include a translation engine that translates received communications into a preferred language of a PSAP operator.

The text analysis engine 204 is configured to analyze text-and keywords in communications to determine if the communication should trigger a cluster or be included in an existing cluster. For example, a communication may include the text “car accident” or “vehicle accident” or some other text where a relatively large volume of communications may be received by the PSAP related to the event of a car or vehicle accident. In some examples, the text analysis engine 204 is a large language model, computer model, and/or machine learning that is configured to use natural language processing (NLP) to analyzes text-for keywords, sentiment, and patterns.

The geographical analysis engine 206 can be configured to analyze communications for a location of the origination of the communication and analyze the geographic data to identify clusters of events and proximity relationships. The location may be general location or precise location. General location can be based on cell tower information if the communication was routed through a cell tower and precise location can be based on GPS coordinates or some other means that can provide relatively precise location data. For example, cell tower information is included in all cellular calls and texts when the cellular calls and text first arrive at a PSAP and the cell tower information can be used to help determine a general location for the origination of the communication. After communication is established with the PSAP, GPS coordinates can be obtained from the device that initiated the communication.

The temporal analysis engine 208 can be configured to analyze the time patterns of communications to identify related communications occurring within a short timeframe. For example, when a communication is received at a PSAP, the communication has a timestamp of when the communication was sent. During a large-scale disaster such as an earthquake, multiple communications may be sent to a PSAP related to the earthquake and the communications will have similar timestamps of when the communications were sent.

The patterns and correlation engine 210 can be configured to analyze multiple communications for patterns or correlations that suggest the communications are related to the same event. For example, the patterns and correlation engine 210 can be configured to identify patterns and correlations between the subject(s) of multiple communications (the subject of a communication can be the event the precipitated the communication and/or the event that is the reason for the communication). In some examples, the patterns and correlation engine 210 is a large language model, computer model, and/or machine learning that is configured to identify patterns and correlations between the subject(s) of multiple communications and cluster the communications.

The cluster creation engine 212 can use the data from one or more of the data receiving engine 202, the text analysis engine 204, the geographical analysis engine 206, the temporal analysis engine 208, and the patterns and correlation engine 210 to determine if a cluster needs to be created or if a communication should be added to a previously created cluster. In some examples, the cluster creation engine 212 can use a large language model, computer model, and/or machine learning to determine if a cluster needs to be created or if a communication should be added to a previously created cluster. In some examples, the cluster creation engine 212 can use clustering algorithms to group similar communications based on features like location, time, and content. Knowledge graphs may also be used to represent relationships between communications and infer connections between communications and events.

Once the cluster creation engine 212 determines that a cluster should be created, either based on a single communication or multiple communications related to a single event, an event cluster for the event is created. The event cluster can be stored or located in the database 216 or some other location and the event cluster serves as a central repository for relevant information about the event. The communications in the event cluster are made available to a specific PSAP operator to provide the specific PSAP operator with a comprehensive overview of the event and facilitate coordinated response efforts. By consolidating information from multiple sources, a specific PSAP operator can gain a more complete picture of the incident, including its scope, severity, and evolving nature. This comprehensive understanding can help enable more informed decisions regarding the deployment of emergency services and help ensure that resources are allocated effectively and efficiently.

The auto message generation engine 214 can be configured to create an auto message in response to a cluster being created for an event. The auto message created by the auto message generation engine 214 can be sent to a user in response to the user sending a communication regarding the event in the cluster. The auto message helps to inform the originator of the communication that the subject event of the communication is known to the PSAP operator and the PSAP is addressing the subject of the event.

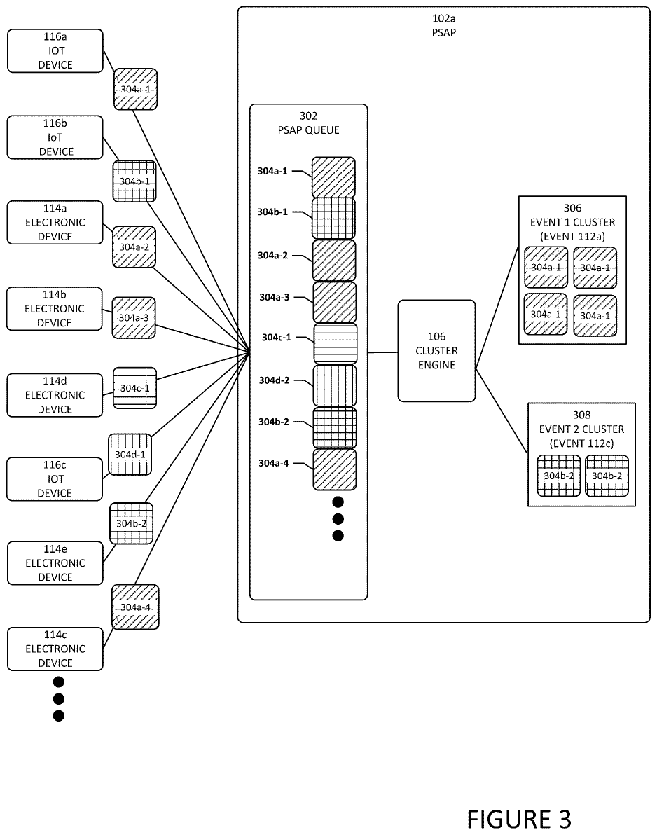

Turning to FIG. 3, FIG. 3 is a simplified block diagram non-limiting illustrative example details of a particular example of the creation of an event cluster. As illustrated in FIG. 3, multiple electronic devices 114 and IoT devices 116 send communications to a PSAP 102a. The communications are received by the PSAP 102a and stored in a general PSAP queue 302 until the next available PSAP operator is available to respond to the communication. The general PSAP queue 302 is a first in first out queue.

More specifically, as illustrated in FIG. 3, the IoT device 116a sends communication 304a-1 to the PSAP 102 where the communication 304a is stored in the general PSAP queue 302. The communication 304a from the IoT device 116a is related to the event 112a (shown in FIGS. 1A and 1B). The IoT device 116b sends communication 304b-1 to the PSAP 102 where the communication 304b-1 is stored in the general PSAP queue 302. The communication 304b-1 from the IoT device 116b is related to the event 112c (shown in FIGS. 1A and 1B). The electronic device 114a sends communication 304a-2 to the PSAP 102 where the communication 304a-2 is stored in the general PSAP queue 302. The communication 304a-2 from the electronic device 114a is related to the event 112a (shown in FIGS. 1A and 1B). The electronic device 114b sends communication 304a-3 to the PSAP 102 where the communication 304a-3 is stored in the general PSAP queue 302. The communication 304a-3 from the electronic device 114b is related to the event 112a (shown in FIGS. 1A and 1B). The electronic device 114d sends communication 304c-1 to the PSAP 102 where the communication 304c-1 is stored in the general PSAP queue 302. The communication 304c-1 from the electronic device 114da is related to the event 112b (shown in FIGS. 1A and 1B). The IoT device 116c sends communication 304d-1 to the PSAP 102 where the communication 304d-1 is stored in the general PSAP queue 302. The communication 304d-1 from the IoT device 116c is related to the event 112d (shown in FIG. 1A). The electronic device 114e sends communication 304b-2 to the PSAP 102 where the communication 304b-2 is stored in the general PSAP queue 302. The communication 304b-2 from the electronic device 114e is related to the event 112c (shown in FIGS. 1A and 1B). The electronic device 114c sends communication 304a-4 to the PSAP 102 where the communication 304a-4 is stored in the general PSAP queue 302. The communication 304a-4 from the electronic device 114c is related to the event 112a (shown in FIGS. 1A and 1B).

The cluster engine 106 can be configured to analyze the communications in the general PSAP queue 302 to determine if a cluster should be created or if a communication should be added to an already existing cluster. For example, based on the data in the communication 304a-1 from the IoT device 116a, the cluster engine 106 can be configured to determine that the event-1 cluster 306 should be created. More specifically, the communication 304a-1 from the IoT device 116a may indicate a severe vehicle accident where several communications regarding the accident are expected. In another example, the communication 304a-1 from the IoT device 116a may indicate a minor vehicle accident or provide data where the severity of the accident is unclear and the cluster engine 106 may determine that a cluster event does not yet need to be created. However, when more communications are received, for example, the communication 304a-2 from the electronic device 114a, more information and data about the event 112a is collected and the cluster engine 106 may determine that the event-1 cluster 306 should be created. After the event-1 cluster 306 is created, further communications related to the event 112a are added to the event-1 cluster 306. More specifically, as the communication 304a-3 related to the event 112a from the electronic device 114b and the communication 304a-4 related to the event 112a from the electronic device 114c are received, the communications 304a-3 and 304a-4 are added to the event-1 cluster 306. The event-1 cluster 306 serves as a central repository for all relevant information about the event 112a. The central repository is made available to a specific PSAP operator to provide the specific PSAP operator with a comprehensive overview of the event 112a and help facilitate coordinated response efforts.

In some examples, an event cluster is created by the cluster engine 106 based on a single communication. For example, as described above, if the communication 304a-1 from the IoT device 116a indicates a severe vehicle accident where several communications regarding the accident are expected, the event-1 cluster 306 can be created by the cluster engine 106 based on just the data in the communication 304a-1 from the IoT device 116a. In other examples, an event cluster is not created based on a single communication. For example, IoT device 116b that sent communication 604b-1 may be a smoke detector and smoke detectors are known for sending false alarms or be triggered by burning food or something else other than an actual fire. In this example, the cluster engine 106 may not create a cluster based on the data in the communication 304b-1 from the IoT device 116b. However, when the electronic device 114e sends the communication 304b-2 regarding the event 112d, the data in the communication 304b-2 can be combined with the data from the communication 304b-1 and the event-2 cluster 308 can be created as the communication 304b-1 from the IoT device 116b is most likely not a false alarm but due to an actual fire.

The event-1 cluster 306 includes communications related to the event 112a and the event-2 cluster 308 includes communications related to the event 112d. The event-1 cluster 306 can be located and/or stored in the database 216 or some other location (e.g., a queue for a first specific PSAP operator) and the event-2 cluster 308 can be located and/or stored in the database 216 or some other location (e.g., a queue for a second specific PSAP operator). The communications in the event-1 cluster 306 are made available to a first PSAP operator to help provide the first specific PSAP operator with a comprehensive overview of the event 112a and help facilitate coordinated response efforts to the event 112a and the event-2 cluster 308 is made available to a second PSAP operator to help provide the second specific PSAP operator with a comprehensive overview of the event 112d and help facilitate coordinated response efforts to the event 112d.

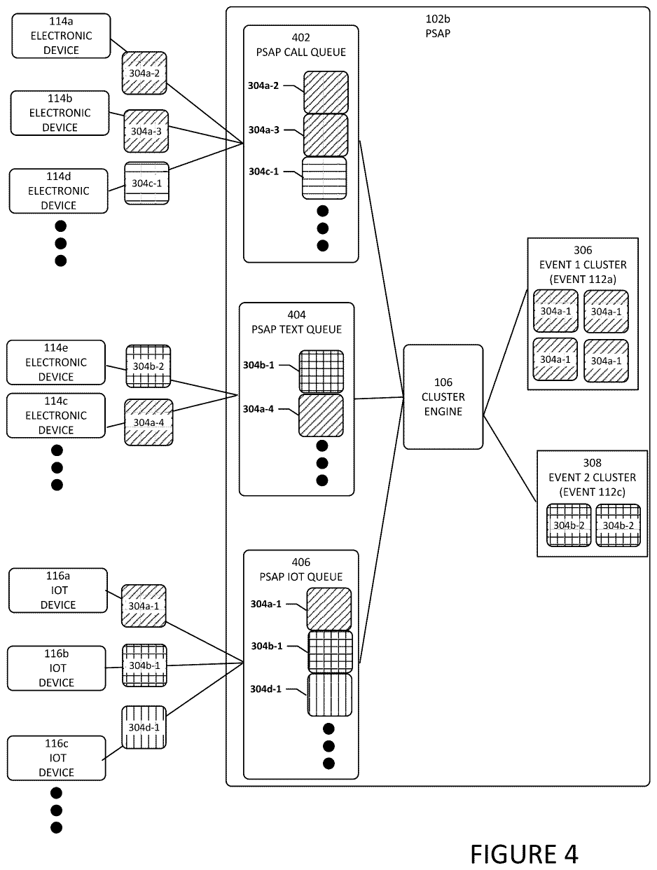

Turning to FIG. 4, FIG. 4 is a simplified block diagram illustrating example details of a particular non-limiting illustrative example of the creation of an event cluster. As illustrated in FIG. 4, multiple electronic devices 114 and IoT devices 116 send communications to a PSAP 102b. The PSAP 102b can include a PSAP call queue 402, a PSAP text queue 404, and a PSAP IoT queue 406. Voice communications from telephonic devices (e.g., landlines, cell phones, TTYL devices, etc.) are received by the PSAP 102b and stored in the PSAP call queue 402 until the next available PSAP operator is available to respond to the voice. The PSAP call queue 402 is a first in first out queue. Text based communications from text enabled devices are received by the PSAP 102b and stored in the PSAP text queue 404 until the next available PSAP operator is available to respond to the voice. The PSAP text queue 404 is a first in first out queue. IoT communications from IoT devices are received by the PSAP 102b and stored in a PSAP IoT queue 406 until the next available PSAP operator is available to respond to the voice. The PSAP IoT queue 406 is a first in first out queue. In some examples one or more of the PSAP call queue 402, the PSAP text queue 404, and/or the PSAP IoT queue 406 are combined into a single queue.

As illustrated in FIG. 4, the IoT device 116a sends a communication 304a-1 to the PSAP 102 where the communication 304a is stored in the PSAP IoT queue 406. The communication 304a from the IoT device 116a is related to the event 112a (shown in FIGS. 1A and 1B). The IoT device 116b sends communication 304b-1 to the PSAP 102 where the communication 304b-1 is stored in the PSAP IoT queue 406. The communication 304b-1 from the IoT device 116b is related to the event 112c (shown in FIGS. 1A and 1B). The electronic device 114a sends communication 304a-2 to the PSAP 102 where, if the communication 304a-2 is a voice communication, the communication 304a-2 is stored in the PSAP call queue 402. The communication 304a-2 from the electronic device 114a is related to the event 112a (shown in FIGS. 1A and 1B). The electronic device 114b sends communication 304a-3 to the PSAP 102 where, if the communication 304a-3 is a voice communication, the communication 304a-3 is stored in the PSAP call queue 402. The communication 304a-3 from the electronic device 114b is related to the event 112a (shown in FIGS. 1A and 1B). The electronic device 114d sends communication 304c-1 to the PSAP 102 where, if the communication 304c-1 is a voice communication, the communication 304c-1 is stored in the PSAP call queue 402. The communication 304c-1 from the electronic device 114d is related to the event 112b (shown in FIGS. 1A and 1B). The IoT device 116c sends communication 304d-1 to the PSAP 102 where the communication 304d-1 is stored in the PSAP IoT queue 406. The communication 304d-1 from the IoT device 116c is related to the event 112d (shown in FIG. 1A). The electronic device 114e sends communication 304b-2 to the PSAP 102 where, if the communication 304b-2 is a text communication, the communication 304b-2 is stored in the PSAP text queue 404. The communication 304b-2 from the electronic device 114e is related to the event 112c (shown in FIGS. 1A and 1B). The electronic device 114c sends communication 304a-4 to the PSAP 102 where, if the communication 304a-4 is a text communication, the communication 304a-4 is stored in the PSAP text queue 404. The communication 304a-4 from the electronic device 114c is related to the event 112a (shown in FIGS. 1A and 1B).

The cluster engine 106 can be configured to analyze the communications in the PSAP call queue 402, the PSAP text queue 404, and the PSAP IoT queue 406 to determine if a cluster should be created or if a communication should be added to an already existing cluster. For example, based on the data in the communication 304a-1 from the IoT device 116a, the cluster engine 106 can be configured to determine that the event-1 cluster 306 should be created. In some examples, an event cluster is created by the cluster engine 106 based on a single communication, as described above with reference to the communication 304a-1. In other examples, an event cluster is not created based on a single communication, as described above with reference to the communication 604b-1.

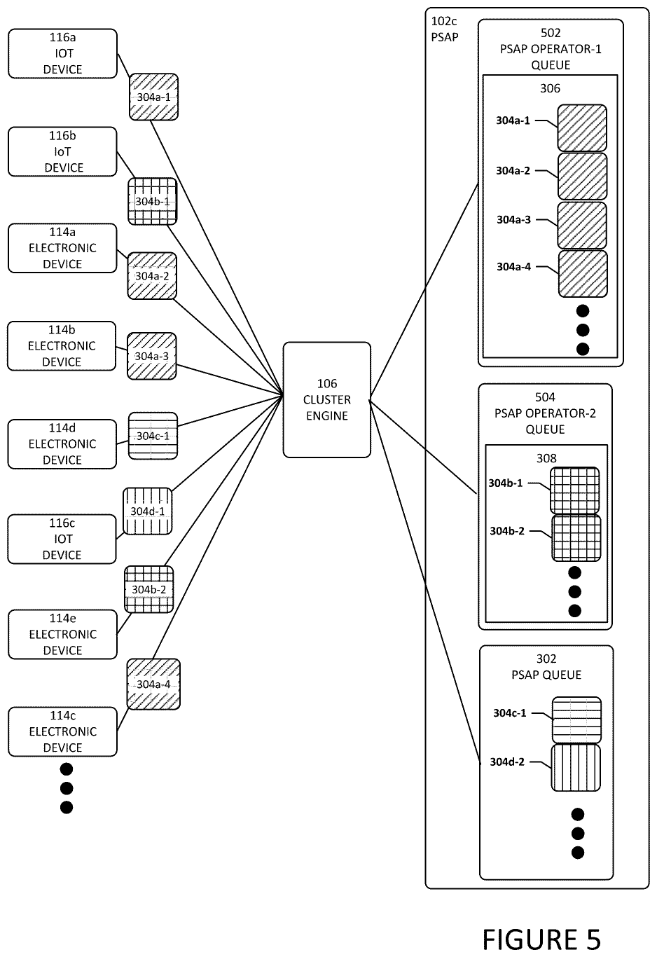

Turning to FIG. 5, FIG. 5 is a simplified block diagram illustrating example details of a particular non-limiting illustrative example of the creation of an event cluster. As illustrated in FIG. 5, multiple electronic devices 114 and IoT devices 116 send communications to a PSAP 102c. The communications are intercepted by the cluster engine 106. As shown in FIG. 5, the cluster engine 106 is outside of the PSAP 102c. More specifically, the cluster engine 106 can be located in the server 120, cloud services 122, and/or a network element 124, as illustrate in FIG. 1B. Before sending the communication to the PSAP 102c, the cluster engine 106 can analyze each communication to determine if a cluster should be created based on the communication, if the communication should be included in a previously created cluster, or if the communication should be sent to a general PSAP queue 302. In some examples, the cluster engine 106 is located in the PSAP 102c and receives and analyzes each communication before the communication is sent to a queue in the PSAP 102.

More specifically, as illustrated in FIG. 5, the IoT device 116a sends communication 304a-1 to the PSAP 102. The cluster engine 106 can intercept the communication 304a-1 and determine if a cluster should be created based on the communication 304a-1, if the communication 304a-1 should be included in a previously created cluster, or if the communication 304a-1 should be sent to a general PSAP queue 302. For example, if the communication 304a-1 from the IoT device 116a indicates a severe vehicle accident where several communications regarding the accident are expected, the cluster engine can create the event-1 cluster 306. The communication 304a-1 from the IoT device 116a is sent to the PSAP 102c where it is sent to a PSAP operator-1 queue 502. The communication 304a from the IoT device 116a is related to the event 112a (shown in FIGS. 1A and 1B).

The IoT device 116b sends communication 304b-1 to the PSAP 102. The communication 304b-1 from the IoT device 116b is related to the event 112c (shown in FIGS. 1A and 1B). The cluster engine 106 can intercept the communication 304b-2 and determine if a cluster should be created based on the communication 304b-1, if the communication 304b-1 should be included in a previously created cluster, or if the communication 304b-1 should be sent to a general PSAP queue 302. For example, if the communication 304b-1 from the IoT device 116a is related to a smoke alarm from a smoke detector, the cluster engine 106 may decide that the communication 304a-1 does not trigger the creation of a cluster and that the communication 304a-1 does not belong in an already created cluster and the communication 304b-1 from the IoT device 116a is sent to the PSAP 102c where it is sent to the general PSAP queue 302 and then sent to a PSAP operator-2 queue 504 as the PSAP operator-2 is the next available PSAP operator.

The electronic device 114a sends communication 304a-2 to the PSAP 102. The cluster engine 106 can intercept the communication 304a-2 and determine if a cluster should be created based on the communication 304a-2, if the communication 304a-2 should be included in a previously created cluster, or if the communication 304a-2 should be sent to a general PSAP queue 302. Because the communication 304a-2 from the electronic device 114a is related to the event 112a (shown in FIGS. 1A and 1B) and event-1 cluster 306 was already created, the cluster engine 106 sends the communication to the PSAP operator-1 queue 502. Because the PSAP operator-1 has already received the communication 304a-1 related to the event 112a, the PSAP operator can use the communication 304a-2 from the electronic device 114a to gain a more complete picture of the event 112a, including its scope, severity, and evolving nature. If the communication 304a-2 from the electronic device 114a was sent to a different PSAP operator, the different PSAP operator may not know about the earlier communication 304a-1 from the IoT device 116a and therefore would not be as informed about the event 112a as the PSAP operator-1 that had previously received the earlier communication 304a-1 from the IoT device 116a.

The electronic device 114b sends communication 304a-3 to the PSAP 102. The cluster engine 106 can intercept the communication 304a-3 and determine if a cluster should be created based on the communication 304a-3, if the communication 304a-3 should be included in a previously created cluster, or if the communication 304a-3 should be sent to a general PSAP queue 302. Because the communication 304a-3 from the electronic device 114a is related to the event 112a (shown in FIGS. 1A and 1B) and event-1 cluster 306 was already created, the cluster engine 106 sends the communication 304a-3 to the PSAP operator-1 queue 502. Because the PSAP operator-1 has already received the communications 304a-1 and 304a-2 related to the event 112a, the PSAP operator can use the communication 304a-3 from the electronic device 114b to gain a more complete picture of the event 112a, including its scope, severity, and evolving nature.

The electronic device 114d sends communication 304c-1 to the PSAP 102. The cluster engine 106 can intercept the communication 304c-1 and determine if a cluster should be created based on the communication 304c-1, if the communication 304c-1 should be included in a previously created cluster, or if the communication 304c-1 should be sent to a general PSAP queue 302. For example, the communication 304c-1 from the electronic device 114d is related to the event 112b (shown in FIGS. 1A and 1B). The cluster engine 106 may determine that a large volume of call is not expected for the event 112b (e.g., a single car minor accident, a cat in a tree, a loud noise nuisance call, etc.) and the communication 304c-1 is sent to the general PSAP queue 302 where the next available PSAP operator will respond to the communication 204c-1.

The IoT device 116c sends communication 304d-1 to the PSAP 102. The cluster engine 106 can intercept the communication 304d-1 and determine if a cluster should be created based on the communication 304d-1, if the communication 304d-1 should be included in a previously created cluster, or if the communication 304d-1 should be sent to a general PSAP queue 302. For example, the communication 304d-1 from the IoT device 116d is related to the event 112d (shown in FIG. 1A). The cluster engine 106 may determine that a large volume of call is not expected for the event 112b (e.g., a single car minor accident, a broken window alarm, etc.) and the communication 304d-1 is sent to the general PSAP queue 302 where the next available PSAP operator will respond to the communication 204d-1.

The electronic device 114e sends communication 304b-2 to the PSAP 102. The communication 304b-2 from the electronic device 114e is related to the event 112c (shown in FIGS. 1A and 1B). The cluster engine 106 can intercept the communication 304b-2-1 and determine if a cluster should be created based on the communication 304b-2, if the communication 304b-2 should be included in a previously created cluster, or if the communication 304b-2 should be sent to a general PSAP queue 302. For example, because communication 304b-2 is related to the event 112c and the communication 304b-1 from the IoT device 116a, a smoke alarm from a smoke detector, was already received, the cluster engine 106 may decide that the communication 304b-2 does trigger the creation of a cluster and cluster 308 is created. Because the communication 304b-1 from the IoT device 116a was previously sent to the PSAP operator-2 queue 504, the communication 304b-1 can also be sent to the PSAP operator-2 queue 504 where the PSAP operator can use the communication 304b-2 from the electronic device 114e to gain a more complete picture of the event 112c, including its scope, severity, and evolving nature.

The electronic device 114c sends communication 304a-4 to the PSAP 102. The cluster engine 106 can intercept the communication 304a-4 and determine if a cluster should be created based on the communication 304a-4, if the communication 304a-4 should be included in a previously created cluster, or if the communication 304a-4 should be sent to a general PSAP queue 302. Because the communication 304a-4 from the electronic device 114c is related to the event 112a (shown in FIGS. 1A and 1B) and event-1 cluster 306 was already created, the cluster engine 106 sends the communication 304a-4 to the PSAP operator-1 queue 502. Because the PSAP operator-1 has already received the communications 304a-1, 304a-2, and 304a-3 related to the event 112a, the PSAP operator can use the communication 304a-4 from the electronic device 114c to gain a more complete picture of the event 112a, including its scope, severity, and evolving nature.

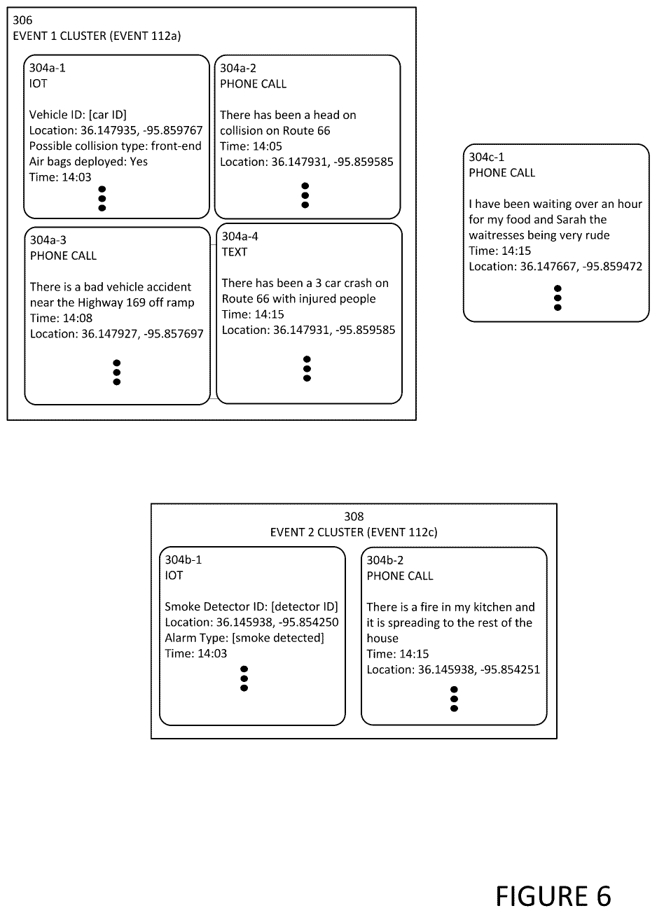

Turning to FIG. 6, FIG. 6 is a simplified block diagram illustrating non-limiting specific example details of communications 304a-1, 304a-2, 304a-3, 304a-4, 304b-1, 304b-2, and 304c-1. As illustrated in FIG. 6, communications 304a-1, 304a-2, 304a-3, 304a-4 are part of the event-1 cluster 306 and communications 304b-1, 304b-2 are part of the event-2 cluster 308. In an example, the event-1 cluster was created based on the communication 304a-1 from the IoT device 116a. More specifically, as illustrated in FIG. 6, the communication 304a-1 indicated a front-end collision where airbags were deployed. Based on the communication 304a-1, the cluster engine 106 may determine that several communications regarding the vehicle accident are expected and the cluster engine 106 created the event-1 cluster 306.

The communications 304a-2, 304a-3, and 304a-4 each have a similar location identifier and originated close to the location from where communication 304a-1 originated. Also, each of the communications 304a-2, 304a-3, and 304a-4 include words related to a vehicle accident (e.g., communication 304a-2 includes the words “head on collision”, communication 304a-3 includes the words “vehicle accident”, and communication 304a-4 includes the words “car crash.”). Because each of the communications 304a-2, 304a-3, and 304a-4 have a similar location identifier and originated close to the location from where communication 304a-1 originated, include words related to a vehicle accident, and possible other similarities that indicate the communications 304a-2, 304a-3, and 304a-4 are related to the same vehicle accident event, the communications 304a-2, 304a-3, and 304a-4 are included in the event-1 cluster 306.

Note that the communication 304c-1 is not included in the event-1 cluster 306, even though the communication 304c-1 has a similar timestamp as the communications 304a-1, 304a-2, 304a-3, and 304a-4 and originated from the same general location. The cluster engine 106 can analyze the communication 304c-1 and determine it is not related to the communications 304a-1, 304a-2, 304a-3, and 304a-4. More specifically, the communication 304c-1 is a nuisance communication or non-PSAP services related communication and is a complaint about service, not about a vehicle accident event.

In some examples, as described above, an event cluster is created by the cluster engine 106 based on a single communication (e.g., event-1 cluster 306 was created based on the communication 304a-1). In other examples, an event cluster is not created based on a single communication. For example, the communication 604b-1 from IoT device 116b be an alert from a smoke detector and smoke detectors are known for sending false alarms. In this example, the cluster engine 106 may not create a cluster based on the data in the communication 304b-1. However, when the electronic device 114e sends the communication 304b-2 regarding the event 112d, the data in the communication 304b-2 can be combined with the data from the communication 304b-1 and the event-2 cluster 308 can be created as it may not be a false alarm but an actual fire. More specifically, the communication 304b-2 may be a phone call from a homeowner regarding a fire in a kitchen. The location and time of the communications 304b-1 and 304b-2 are similar and the cluster engine 106 can analyze the communications 304b-1 and 304b-2 and determine the are related to the same event (e.g., a fire) and the cluster engine 106 can create the event-2 cluster 308.

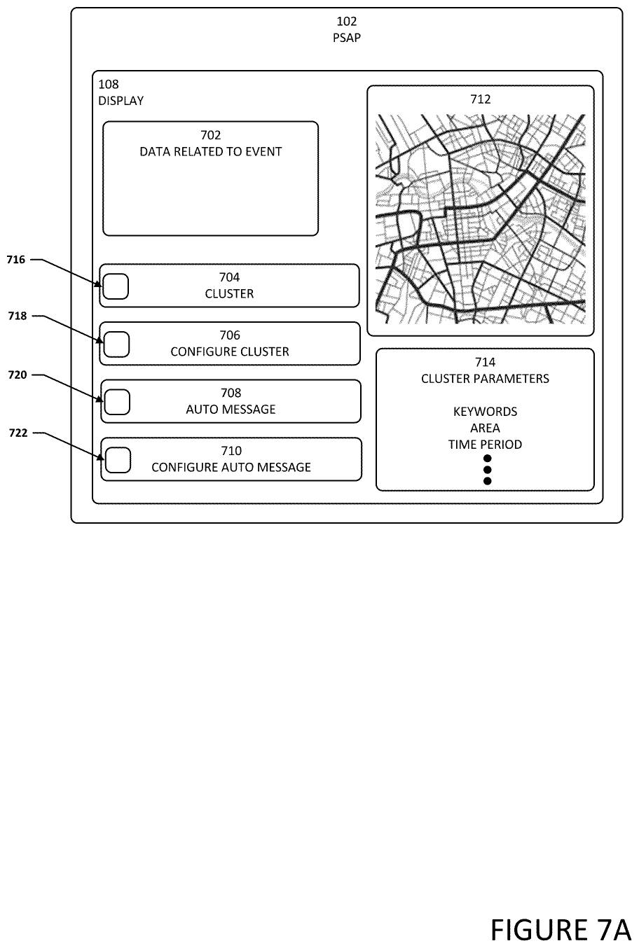

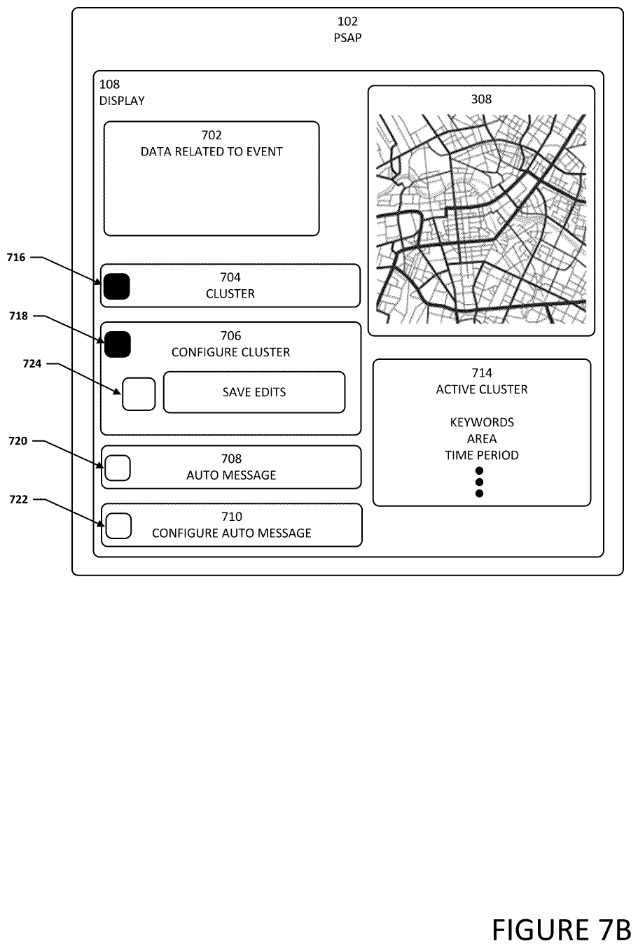

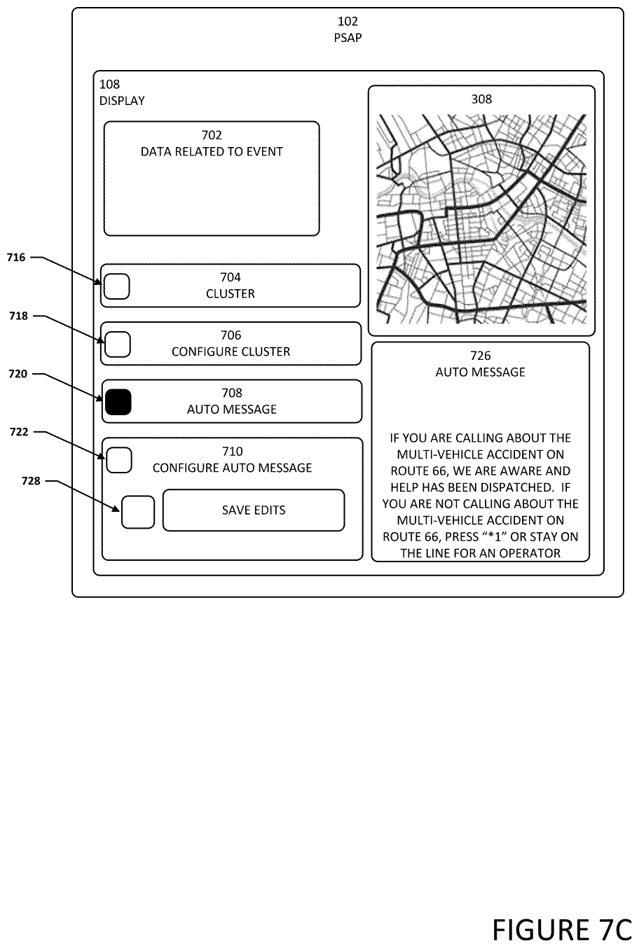

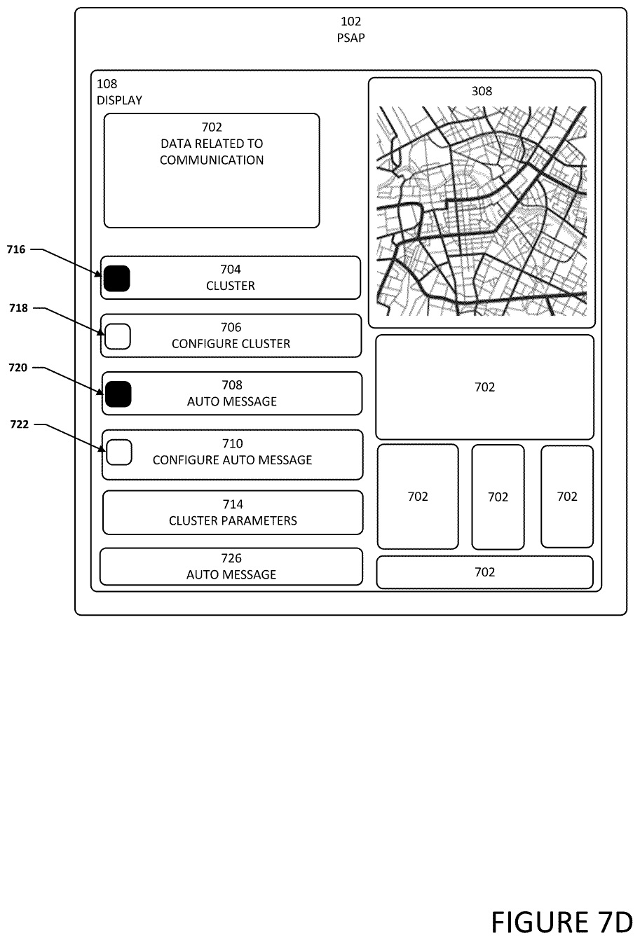

Turning to FIGS. 7A-7D, FIGS. 7A-7D are simplified block diagrams illustrating non-limiting examples details of the PSAP display 108 at the PSAP 102. The PSAP display 108 can be a display that is viewed by a human operator at the PSAP 102. Note that that PSAP display 108 can display other information to the human operator at the PSAP 102, the information on the PSAP display 108 may be presented in a different way, and/or the information on the PSAP display 108 may be in a different layout.

As illustrated in FIG. 7A, the PSAP display 108 can include a data related to the event portion 702, an activate cluster portion 704, a configure cluster portion 706, an activate auto message portion 708, a configure auto message portion 710, and an incident representation 712. The data related to the event portion 702 can include data related to the event (e.g., event 112a) that is the subject of the communication (e.g., communication 304c-1). More specifically, the data related to the event portion 702 can include a location of the event, the type of event (e.g., a fire, car accident, robbery, etc.), type and/or location of emergency services needed to respond to the event and other details a human PSAP operator may need to help enable the PSAP operator or other response personal respond to the event. As illustrated in FIG. 7, a cluster has been suggested by the cluster engine 106 (illustrated in FIGS. 1A and 1B) and but not yet activated. The parameters of the suggested cluster can be displayed in a cluster parameters portion 714 of the PSAP display 108. In an illustrative example, the PSAP operator can click, select, or otherwise toggle an active cluster indicator 716 to activate the cluster.

As illustrated in FIG. 7B, the active cluster indicator 716 indicates the cluster has been activated and the cluster parameters portion 714 of the PSAP display 108 illustrates the parameters of the active cluster. In some examples, the PSAP operator can click, select, or otherwise toggle a configure cluster indicator 718 to configure and change the parameters of the cluster. When the configure cluster indicator 718 is clicked, selected, or otherwise toggled, the PSAP operator can edit the parameters of the cluster in the cluster parameters portion 714. The parameters of the cluster can be edited both before the cluster is activated and after the cluster is activated. A save edits indicator 724 can be clicked, selected, or otherwise toggled to save any edits to the parameters of the cluster.

As illustrated in FIG. 7C, the cluster engine 106 can generate an auto message when a cluster is created. The auto message can be automatically activated or a PSAP operator can activate an auto message suggested by the cluster engine 106. When the cluster engine 106 determines that a communication belongs in a previously created cluster, the cluster engine 106 can send the auto message in response to the communication.

More specifically, as illustrated in FIG. 7C, in response to the cluster engine 106 creating the event-1 cluster 306, the cluster engine 106 also created an auto message. The created auto message is shown in FIG. 7C in the auto message portion 726. In an illustrative example, the PSAP operator can click, select, or otherwise toggle an active auto message indicator 720 to activate the auto message. In some examples, when a cluster is created, an auto message is automatically activated. The PSAP operator can click, select, or otherwise toggle a configure auto message indicator 722 to configure and change the wording of the auto message. When the configure auto message indicator 722 is clicked, selected, or otherwise toggled, the PSAP operator can edit the auto message in the auto message portion 726. The auto message can be edited both before the auto message is activated and after the auto message is activated. A save auto message edits indicator 728 can be clicked, selected, or otherwise toggled to save any edits to the auto message.

When a cluster and/or an auto message are activated and a PSAP operator is responding to communications related to an event in the cluster, the PSAP display 108 can be configured as illustrated in FIG. 7D. Note that the information on the PSAP display 108 may be presented in a different way, and/or the information on the PSAP display 108 may be in a different layout. The PSAP operator can click, select, or otherwise toggle the cluster parameters portion 714 to view the current parameters for the active cluster and can click, select, or otherwise toggle the auto message portion 726 to view the wording of the auto message.

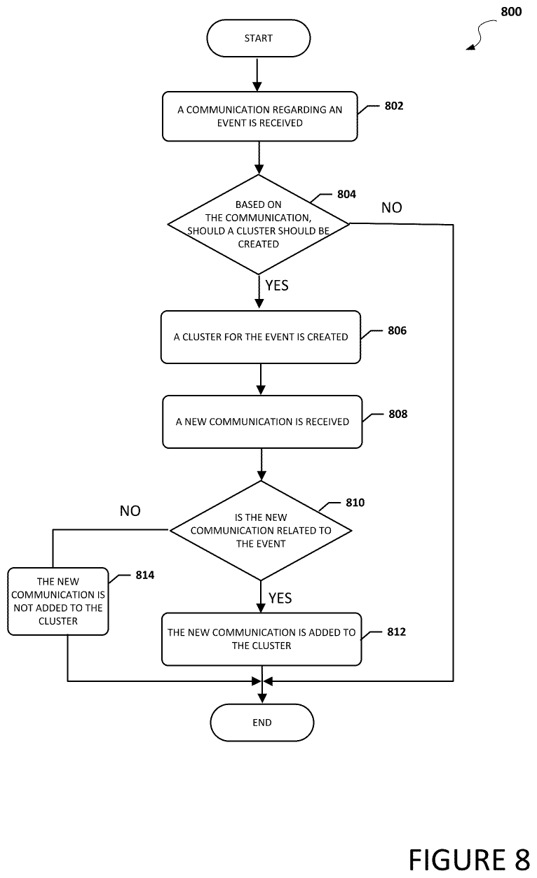

Turning to FIG. 8, FIG. 8 is example flowchart illustrating possible operations of a flow 800 that may be associated with potential operations to help enable the creation of an event cluster, in accordance with an embodiment of the present disclosure. Specifically, in some examples, one or more operations of flow 800 may be performed by the cluster engine 106, the data receiving engine 202, the text analysis engine 204, the geographical analysis engine 206, the temporal analysis engine 208, the patterns and correlation engine 210, the cluster creation engine 212, and/or the auto message generation engine 214. At 802, a communication regarding an event is received. For example, the cluster engine 106 in the PSAP 102 can receive a communication or the cluster engine 106 in the server 120, cloud services 122, or network element 124 can received a communication. In some examples, the PSAP 102 receives a communication and stores the communication in a queue until the next available PSAP operator. At 804, the system determines, based on the communication, if a cluster should be created. For example, the cluster engine 106 can determine if a cluster should be created based on the communication. In some examples, the cluster engine 106 uses a computer model or machine learning to analyze the data and/or metadata in the communication to determine if the data and/or metadata indicates a cluster should be created. If a cluster should not be created, the process ends.

If a cluster should be created, a cluster for the event is created, as in 806. At 808, a new communication is received. At 810, the system determines if the new communication is related to the event. If the new communication is related to the event, the new communication is added to the cluster, as in 812. If the new communication is not related to the event, the new communication is not added to the cluster, as in 814. By combining communications related to the same event in a cluster, a PSAP operator can gain a more complete picture of the event, including its scope, severity, and evolving nature.

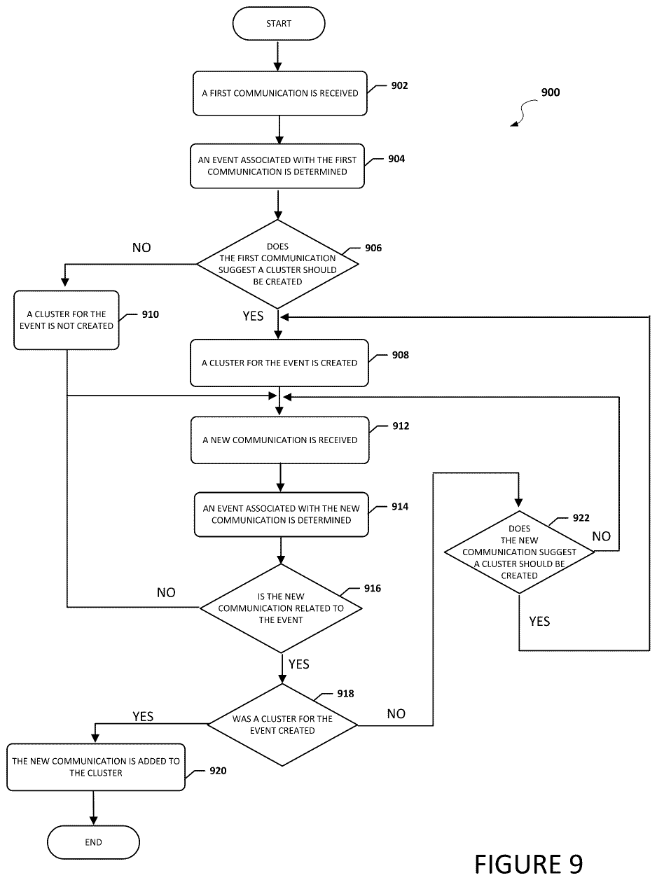

Turning to FIG. 9, FIG. 9 is example flowchart illustrating possible operations of a flow 900 that may be associated with potential operations to help enable the creation of an event cluster, in accordance with an embodiment of the present disclosure. Specifically, in some examples, one or more operations of flow 900 may be performed by the cluster engine 106, the data receiving engine 202, the text analysis engine 204, the geographical analysis engine 206, the temporal analysis engine 208, the patterns and correlation engine 210, the cluster creation engine 212, and/or the auto message generation engine 214. At 902, a first communication is received. For example, the cluster engine 106 in the PSAP 102 can receive a first communication or the cluster engine 106 in the server 120, cloud services 122, or network element 124 can received a first communication. In some examples, the PSAP 102 receives a first communication and stores the first communication in a queue until the next available PSAP operator. At 904, an event associated with the first communication is determined. For example, the communication may be the communication 304a-1 associated with the event 112a.

At 906, the system determines if the first communication suggests a cluster for the event should be created. For example, the cluster engine 106 can determine if a cluster should be created based on the communication. In some examples, the cluster engine 106 uses a computer model or machine learning to analyze the data and/or metadata in the communication to determine if the data and/or metadata indicates a cluster should be created. If the first communication suggests a cluster should be created, a cluster for the event is created, as in 908. If the communication suggests a cluster should be not created, a cluster for the event is not created, as in 910. At 912, a new communication is received. At 914, an event associated with the new communication is determined.

At 916, the system determines if the new communication is related to the event. If the new communication is not related to the event, the system returns to 912 and another new communication is received. If the new communication is related to the event, the system determines if a cluster for the event was created, as in 918. If a cluster was created for the event, the new communication is added to the cluster, as in 920. If a cluster was not created for the event, the system determines if the new communication suggests a cluster for the event should be created, as in 922. If the new communication suggests a cluster should be created for the event, a cluster for the event is created, as in 908. By combining communications related to the same event in a cluster, the PSAP operator can gain a more complete picture of the event, including its scope, severity, and evolving nature. If the new communication does not suggest a cluster should be created, they system returns to 912 and another new communication is received.

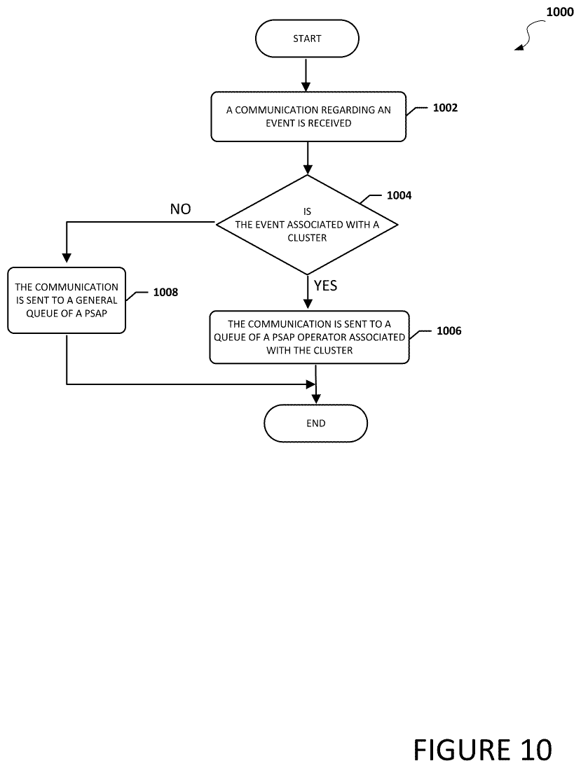

Turning to FIG. 10, FIG. 10 is example flowchart illustrating possible operations of a flow 1000 that may be associated with potential operations to help enable the creation of an event cluster, in accordance with an embodiment of the present disclosure. Specifically, in some examples, one or more operations of flow 1000 may be performed by the cluster engine 106, the data receiving engine 202, the text analysis engine 204, the geographical analysis engine 206, the temporal analysis engine 208, the patterns and correlation engine 210, the cluster creation engine 212, and/or the auto message generation engine 214. At 1002, a communication regarding an event is received. At 1004, the system determines if the event is associated with a cluster. If the event is associated with a cluster, the communication is sent to a queue of a PSAP operator that is associated with the cluster, as in 1006. By combining communications related to the same event in a cluster, the PSAP operator can gain a more complete picture of the event, including its scope, severity, and evolving nature. If the event is not associated with a cluster, the communication is sent to a general queue of a PSAP, as in 1008.

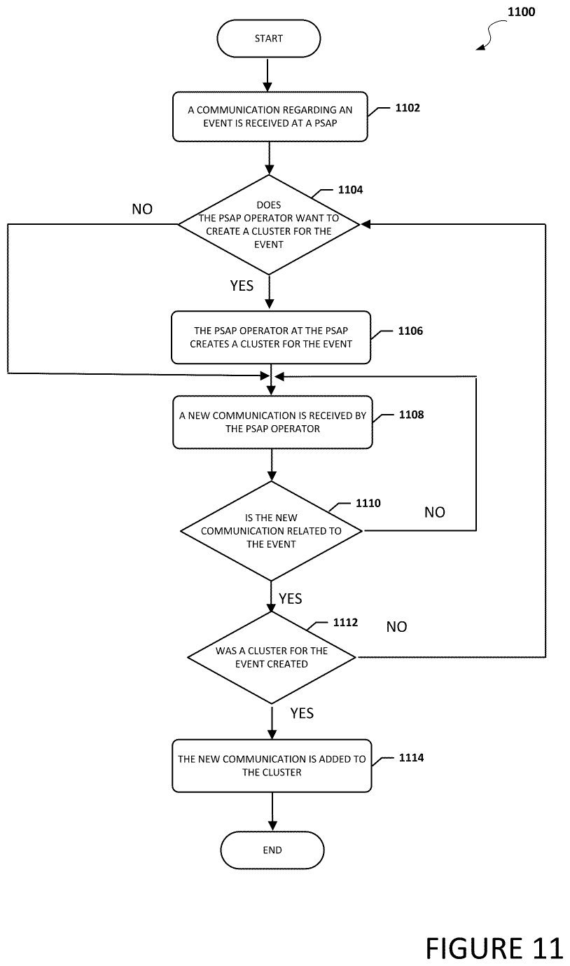

Turning to FIG. 11, FIG. 11 is example flowchart illustrating possible operations of a flow 1100 that may be associated with potential operations to help enable the creation of an event cluster, in accordance with an embodiment of the present disclosure. Specifically, in some examples, one or more operations of flow 1100 may be performed by the cluster engine 106, the data receiving engine 202, the text analysis engine 204, the geographical analysis engine 206, the temporal analysis engine 208, the patterns and correlation engine 210, the cluster creation engine 212, and/or the auto message generation engine 214. At 1102, a communication regarding an event is received at a PSAP. At 1104, the system determines if a PSAP operator wants to create a cluster for the event. If the PSAP operator wants to create a cluster for the event, the PSAP operator at the PSAP creates a cluster for the event, as in 1106. For example, the PSAP operator can click, select, or otherwise toggle an active cluster indicator 716 to activate a cluster for the event. At 1108, a new communication is received by the PSAP operator. Going back to 1104, if the PSAP operator does not want to create a cluster for the event, a new communication is received by the PSAP operator, as in 1108.

At 1110, the system determines if the new communication is related to the event. If the new communication is related to the event, the system determines if a cluster for the event was created, as in 1112. If a cluster was created for the event, the new communication is added to the cluster, as in 114. If the cluster was not created for the event, the system determines if the PSAP operator wants to create a cluster for the event, as in 1104. Going back to 1110, if the new communication is not related to the event, the communication is addressed by the PSAP operator and a new communication is received by the PSAP operator, as in 1108.

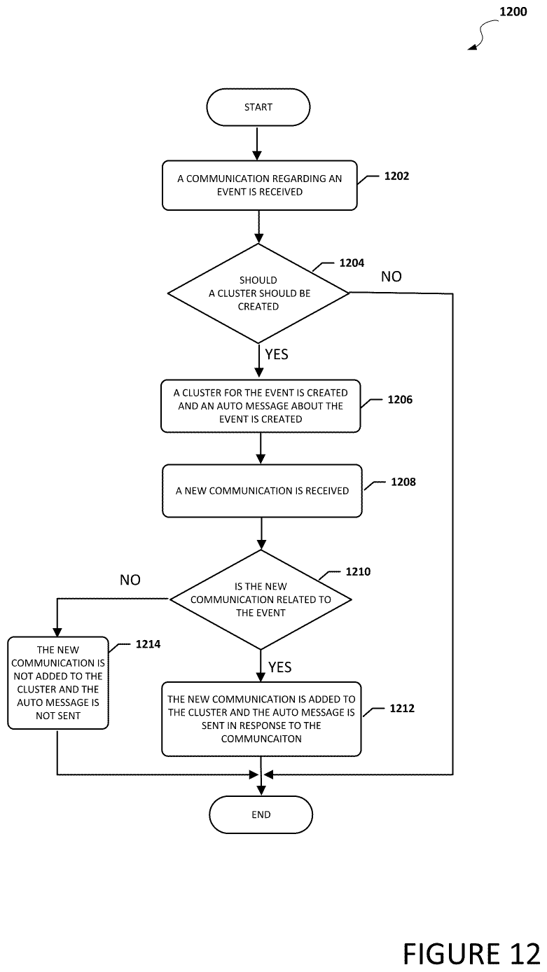

Turning to FIG. 12, FIG. 12 is example flowchart illustrating possible operations of a flow 1200 that may be associated with potential operations to help enable the creation of an event cluster, in accordance with an embodiment of the present disclosure. Specifically, in some examples, one or more operations of flow 1200 may be performed by the cluster engine 106, the data receiving engine 202, the text analysis engine 204, the geographical analysis engine 206, the temporal analysis engine 208, the patterns and correlation engine 210, the cluster creation engine 212, and/or the auto message generation engine 214. At 1202, a communication regarding an event is received. For example, the cluster engine 106 in the PSAP 102 can receive a communication or the cluster engine 106 in the server 120, cloud services 122, or network element 124 can received a communication. In some examples, the PSAP 102 receives a communication and stores the communication in a queue until the next available PSAP operator. At 1204, the system determines if a cluster should be created. For example, the cluster engine 106 can determine if a cluster should be created based on the communication. In some examples, the cluster engine 106 uses a computer model or machine learning to analyze the data and/or metadata in the communication to determine if the data and/or metadata indicates a cluster should be created. If a cluster should not be created, the process ends.

If a cluster should be created, a cluster for the event is created and an auto message about the event is crated, as in 1206. At 1208, a new communication is received. At 1210, the system determines if the new communication is related to the event. If the new communication is related to the event, the new communication is added to the cluster and the auto message is sent in response to the communication, as in 1212. If the new communication is not related to the event, the new communication is not added to the cluster and the auto message is not sent, as in 1214. By combining communications related to the same event in a cluster, a PSAP operator can gain a more complete picture of the event, including its scope, severity, and evolving nature. Also, the auto message helps to inform the originator of the communication that the subject event of the communication is known to the PSAP operator and the PSAP is addressing the subject of the event.

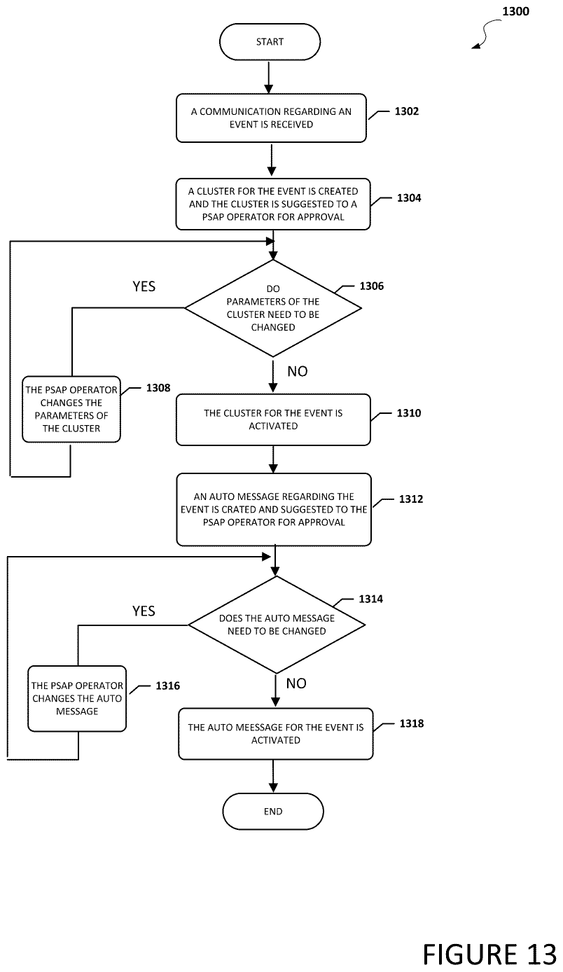

Turning to FIG. 13, FIG. 13 is example flowchart illustrating possible operations of a flow 1300 that may be associated with potential operations to help enable the creation of an event cluster, in accordance with an embodiment of the present disclosure. Specifically, in some examples, one or more operations of flow 1300 may be performed by the cluster engine 106, the data receiving engine 202, the text analysis engine 204, the geographical analysis engine 206, the temporal analysis engine 208, the patterns and correlation engine 210, the cluster creation engine 212, and/or the auto message generation engine 214. At 1302, a communication regarding an event is received. At 1304, a cluster for the event is crated and the cluster is suggested to a PSAP operator for approval. At 1306, the system determines if the parameters of the cluster need to be changed. If the parameters of the cluster need to be changed, the PSAP operator changes the parameters of the cluster, as in 1308. At 1306, the system determines if the parameters of the cluster need to be changed. If the parameters of the cluster do not need to be changed, the cluster for the event is activated, as in 1310.

At 1312, an auto message regarding the event is created and suggested to the PSAP operator for approval. At 1314, the system determines if the auto message needs to be changed. If the auto message needs to be changed, the PSAP operator changes the auto message, as in 1316. At 1314, the system determines if the auto message needs to be changed. If the auto message does not need to be changed, the auto message for the event is activated, as in 1318.

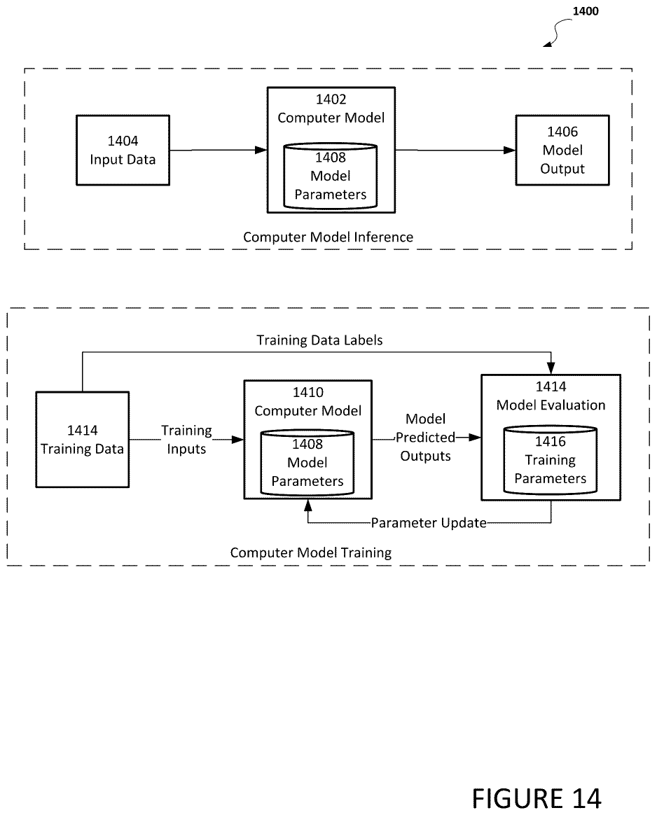

Turning to FIG. 14, FIG. 14 illustrates example computer model inference and computer model training 1400. Computer model inference refers to the application of a computer model 1402 to a set of input data 1404 to generate an output or model output 1406. The computer model 1402 determines the model output 1406 based on parameters of the model, also referred to as model parameters 1408. The parameters of the model may be determined based on a training process that finds an optimization of the model parameters 1408, typically using training data and desired outputs of the model for the respective training data as discussed below. The output (e.g., if a cluster should be created or if a communication should be added to an existing cluster) of the computer model 1402 may be referred to as an “inference” because it is a predictive value based on the input data 1404 and based on previous example data used in the model training.

The input data 1404 and the model output 1406 vary according to the particular use case. For example, to determine if a cluster should be created or if a communication should be added to an existing cluster, the input data 1404 may be data from one or more communications and the output or “inference” may be a score or some other indication of the likelihood that a cluster should be created or if the communication should be added to an existing cluster.

In an illustrative example to determine if a cluster should be created or if a communication should be added to an existing cluster, natural language processing (NLP) can be used to analyze communications for keywords, sentiment, and patterns. In some examples, clustering algorithms can be used to group similar communications based on features like location, time, and content. In addition, geographical information systems (GIS) can analyze geographic data to identify clusters of events and proximity relationships. Temporal analysis may be used to analyze the time patterns of communications to identify related events occurring within a short timeframe. Knowledge graphs may also be used to construct knowledge graphs to represent relationships between entities and infer connections between events.

In an illustrative example of classifications of portions of an image, computer vision and image analysis, the input data 1404 may be an image having a particular resolution, such as 75×75 pixels, or a point cloud describing a volume. In other applications, the input data 1404 may include a vector, such as a sparse vector, representing information about an object. For example, in recommendation systems, such a vector may represent user-object interactions, such that the sparse vector indicates individual items positively rated by a user. In addition, the input data 1404 may be a processed version of another type of input object, for example representing various features of the input object or representing preprocessing of the input object before input of the object to the computer model 1402. As one example, a 1024×1024 resolution image may be processed and subdivided into individual image portions of 64×64, which are the input data 1404 processed by the computer model 1402. As another example, the input object, such as a sparse vector discussed above, may be processed to determine an embedding or another compact representation of the input object that may be used to represent the object as the input data 1404 in the computer model 1402.

Such additional processing for input objects may themselves be learned representations of data, such that another computer model processes the input objects to generate an output that is used as the input data 1404 for the computer model 1402. Although not further discussed here, such further computer models may be independently or jointly trained with the computer model 1402. As noted above, the model output 1406 may depend on the particular application of the computer model 1402, for example, the creation of an event cluster.

The computer model 1402 includes various model parameters 1408, as noted above, that describe the characteristics and functions that generate the model output 1406 from the input data 1404. In particular, the model parameters 1408 may include a model structure, model weights, and a model execution environment. The model structure may include, for example, the particular type of computer model 1402 and its structure and organization. For example, the model structure may designate a neural network, which may be comprised of multiple layers, and the model parameters 1408 may describe individual types of layers included in the neural network and the connections between layers (e.g., the output of which layers constitute inputs to which other layers). Such networks may include, for example, feature extraction layers, convolutional layers, pooling/dimensional reduction layers, activation layers, output/predictive layers, and so forth. While in some instances the model structure may be determined by a designer of the computer model, in other examples, the model structure itself may be learned via a training process and may thus form certain “model parameters” of the model.

The model weights may represent the values with which the computer model 1402 processes the input data 1404 to the model output 1406. Each portion or layer of the computer model 1402 may have such weights. For example, weights may be used to determine values for processing inputs to determine outputs at a particular portion of a model. Stated another way, for example, model weights may describe how to combine or manipulate values of the input data 1404 or thresholds for determining activations as output for a model. As one example, a convolutional layer typically includes a set of convolutional “weights,” also termed a convolutional kernel, to be applied to a set of inputs to that layer. These are subsequently combined, typically along with a “bias” parameter, and weights for other transformations to generate an output for the convolutional layer. For example, the term “severe accident” may be weighted more than the term “vehicle accident.”

The model execution parameters represent parameters describing the execution conditions for the model. In particular, aspects of the model may be implemented on various types of hardware or circuitry for executing the computer model 1402. For example, portions of the model may be implemented in various types of circuitry, such as general-purpose circuity (e.g., a general CPU), circuity specialized for certain functions (e.g., a GPU or programmable Multiply-and-Accumulate circuit) or circuitry specially designed for the particular computer model application. In some configurations, different portions of the computer model 1402 may be implemented on different types of circuitries. As discussed below, training of the model may include optimizing the types of hardware used for certain aspects of the computer model 1402 (e.g., co-trained), or may be determined after other parameters for the computer model 1402 are determined without regard to configuration executing the model. In another example, the execution parameters may also determine or limit the types of processes or functions available at different portions of the model, such as value ranges available at certain points in the processes, operations available for performing a task, and so forth.

Computer model training may thus be used to determine or “train” the values of the model parameters 1408 for the computer model 1410. During training, the model parameters 1408 are optimized to “learn” values of the model parameters (such as individual weights, activation values, model execution environment, etc.), that improve the model parameters 1408 based on an optimization function that seeks to improve a cost function (also sometimes termed a loss function). Before training, the computer model 1410 has model parameters 1408 that have initial values that may be selected in various ways, such as by a randomized initialization, initial values selected based on other or similar computer models, or by other means. During training, the model parameters are modified based on the optimization function to improve the cost/loss function relative to the prior model parameters.

In many applications, training data 1414 includes a data set to be used for training the computer model 1410. The data set varies according to the particular application and purpose of the computer model 1410. In supervised learning tasks, the training data 1412 typically includes a set of training data labels that describe the training data 1412 and the desired output of the model relative to the training data 1412. For example, for a cluster creation and assignment task, the training data 1412 may include communications collected during an emergency event and labeled with the classification of the emergency event. For this task, the training data 1412 may include the communications related to the emergency event, such that the computer model 1410 is intended to learn to also label the same type of communications as being related to the same emergency event and therefore belong in the same cluster.

To train the computer model 1410, a training module (not shown) applies the training inputs to the computer model 1410 to determine the outputs predicted by the model for the given training inputs. The training module, though not shown, is a computing module used for performing the training of the computer model 1410 by executing the computer model 1410 according to its inputs and outputs given the model's parameters and modifying the model parameters based on the results. The training module may apply the actual execution environment of the computer model 1410, or may simulate the results of the execution environment, for example to estimate the performance, runtime, memory, or circuit area (e.g., if specialized hardware is used) of the computer model 1410. The training module, along with the training data 1412 and model evaluation, may be instantiated in software and/or hardware by one or more processing devices. In various examples, the training process may also be performed by multiple computing systems in conjunction with one another, such as distributed/cloud computing systems. In some examples the training of the computer module 1410 may be different if the computer model 1410 is a large language model (LLM) used for automated message responses as compared to being used to determine if a cluster should be created or if a communication should be added to an existing cluster. A large language model is used for language-based tasks, whereas the general AI model or computer model can be used for a variety of other tasks, including to determine if a cluster should be created or if a communication should be added to an existing cluster.

After processing the training inputs according to the current model parameters for the computer model 1410, the model's predicted outputs are evaluated and the computer model 1410 is evaluated with respect to the cost function and optimized using an optimization function of the training model. Depending on the optimization function, particular training process and training parameters 1416 after the model evaluation are updated to improve the optimization function of the computer model 1410. In supervised training (i.e., training data labels are available), the cost function may evaluate the model's predicted outputs relative to the training data labels and to evaluate the relative cost or loss of the prediction relative to the “known” labels for the data. This provides a measure of the frequency of correct predictions by the computer model 1410 and may be measured in various ways, such as the precision (frequency of false positives) and recall (frequency of false negatives). The cost function in some circumstances may also evaluate other characteristics of the model, for example the model complexity, processing speed, memory requirements, physical circuit characteristics (e.g., power requirements, circuit throughput) and other characteristics of the computer model 1410 structure and execution environment (e.g., to evaluate or modify these model parameters).

After determining results of the cost function, the optimization function determines a modification of the model parameters to improve the cost function for the training data 1412. Many such optimization functions are known to one skilled on the art. Many such approaches differentiate the cost function with respect to the parameters of the model and determine modifications to the model parameters that thus improves the cost function. The parameters for the optimization function, including algorithms for modifying the model parameters are the training parameters 1416 for the optimization function. For example, the optimization algorithm may use gradient descent (or its variants), momentum-based optimization, or other optimization approaches used in the art and as appropriate for the particular use of the model. The optimization algorithm thus determines the parameter updates to the model parameters. In some implementations, the training data 1412 is batched and the parameter updates are iteratively applied to batches of the training data 1412. For example, the model parameters may be initialized, then applied to a first batch of data to determine a first modification to the model parameters. The second batch of data may then be evaluated with the modified model parameters to determine a second modification to the model parameters, and so forth, until a stopping point, typically based on either the amount of training data 1412 available or the incremental improvements in model parameters are below a threshold (e.g., additional training data 1412 no longer continues to improve the model parameters). Additional training parameters 1416 may describe the batch size for the training data 1412, a portion of training data 1412 to use as validation data, the step size of parameter updates, a learning rate of the model, and so forth. Additional techniques may also be used to determine global optimums or address nondifferentiable model parameter spaces.

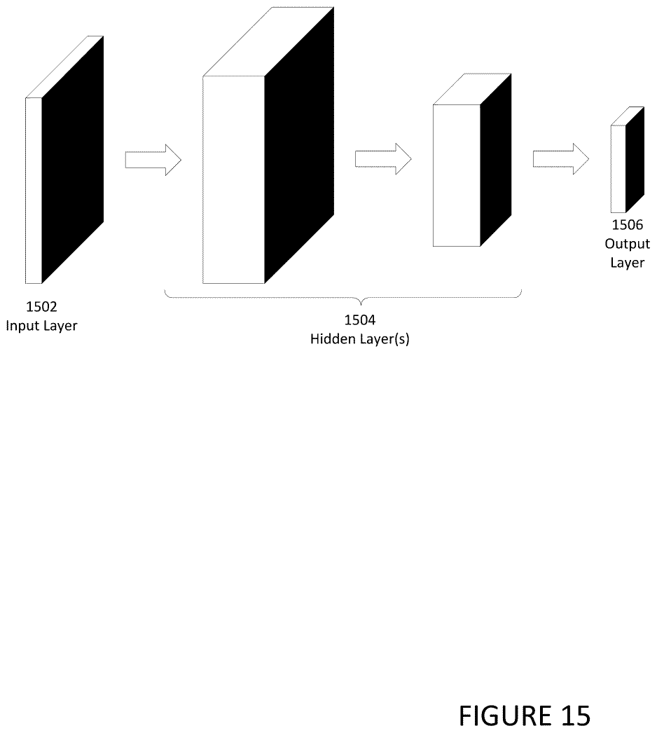

Turning to FIG. 15, FIG. 15 illustrates an example neural network architecture. In general, a neural network includes an input layer 1502, one or more hidden layers 1504, and an output layer 1506. The values for data in each layer of the network is generally determined based on one or more prior layers of the network. Each layer of a network generates a set of values, termed “activations” that represent the output values of that layer of a network and may be the input to the next layer of the network. For the input layer 1502, the activations are typically the values of the input data, although the input layer 1502 may represent input data as modified through one or more transformations to generate representations of the input data. For example, in recommendation systems, interactions between users and objects may be represented as a sparse matrix. Individual users or objects may then be represented as an input layer 1502 as a transformation of the data in the sparse matrix relevant to that user or object. The neural network may also receive the output of another computer model (or several), as its input layer 1502, such that the input layer 1502 of the neural network shown in FIG. 15 is the output of another computer model. Accordingly, each layer may receive a set of inputs, also termed “input activations,” representing activations of one or more prior layers of the network and generate a set of outputs, also termed “output activations” representing the activation of that layer of the network. Stated another way, one layer's output activations become the input activations of another layer of the network, except for the final output layer of 1506 of the network.

Each layer of the neural network typically represents its output activations (i.e., also termed its outputs) in a matrix, which may be 1, 2, 3, or n-dimensional according to the particular structure of the network. As shown in FIG. 15, the dimensionality of each layer may differ according to the design of each layer. The dimensionality of the output layer 1506 depends on the characteristics of the prediction made by the model. For example, a computer model for multi-object classification may generate an output layer 1506 having a one-dimensional array in which each position in the array represents the likelihood of a different classification for the input layer 1502. In another example for classification of portions of an image, the input layer 1502 may be an image having a resolution, such as 512×512, and the output layer may be a 512×512×n matrix in which the output layer 1506 provides n classification predictions for each of the input pixels, such that the corresponding position of each pixel in the input layer 1502 in the output layer 1506 is an n-dimensional array corresponding to the classification predictions for that pixel.

The hidden layers 1504 provide output activations that variously characterize the input layer 1502 in various ways that assist in effectively generating the output layer 1506. The hidden layers thus may be considered to provide additional features or characteristics of the input layer 1502. Though two hidden layers are shown in FIG. 15, in practice any number of hidden layers may be provided in various neural network structures.

Each layer generally determines the output activation values of positions in its activation matrix based on the output activations of one or more previous layers of the neural network (which may be considered input activations to the layer being evaluated). Each layer applies a function to the input activations to generate its activations. Such layers may include fully-connected layers (e.g., every input is connected to every output of a layer), convolutional layers, deconvolutional layers, pooling layers, and recurrent layers. Various types of functions may be applied by a layer, including linear combinations, convolutional kernels, activation functions, pooling, and so forth. The parameters of a layer's function are used to determine output activations for a layer from the layer's activation inputs and are typically modified during the model training process. The parameters describing the contribution of a particular portion of a prior layer is typically termed a weight. For example, in some layers, the function is a multiplication of each input with a respective weight to determine the activations for that layer. For a neural network, the parameters for the model as a whole thus may include the parameters for each of the individual layers and in large-scale networks can include hundreds of thousands, millions, or more of different parameters.

As one example for training a neural network, the cost function is evaluated at the output layer 1506. To determine modifications of the parameters for each layer, the parameters of each prior layer may be evaluated to determine respective modifications. In one example, the cost function (or “error”) is backpropagated such that the parameters are evaluated by the optimization algorithm for each layer in sequence, until the input layer 1502 is reached.

In the description, various aspects of the illustrative implementations are described using terms commonly employed by those skilled in the art to convey the substance of their work to others skilled in the art. However, it will be apparent to those skilled in the art that the embodiments disclosed herein may be practiced with only some of the described aspects. For purposes of explanation, specific numbers, materials, and configurations are set forth in order to provide a thorough understanding of the illustrative implementations. However, it will be apparent to one skilled in the art that the embodiments disclosed herein may be practiced without the specific details. In other instances, well-known features are omitted or simplified in order not to obscure the illustrative implementations.

In the detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). Reference to “one embodiment” or “an embodiment” in the present disclosure means that a particular feature, structure, or characteristic described in connection with the embodiment is included in at least one embodiment. The appearances of the phrase “in one embodiment” or “in an embodiment” are not necessarily all referring to the same embodiment. Reference to “one example” or “an example” in the present disclosure means that a particular feature, structure, or characteristic described in connection with the embodiment is included in at least one example or embodiment. The appearances of the phrase “in one example” or “in an example” are not necessarily all referring to the same examples or embodiments. The terms “substantially,” “close,” “approximately,” “near,” and “about,” generally refer to being within +/−20% of a target value based on the context of a particular value as described herein or as known in the art.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur. Substantial flexibility is provided by the system, apparatus, and a method to enable the creation of an event cluster in that any suitable arrangements, chronologies, configurations, and timing mechanisms may be provided without departing from the teachings of the present disclosure.

Note that embodiments of the PSAP 102, the communication engine 104, the cluster engine 106, the server 120, cloud services 122, and the network element 124, may include one or more distinct interfaces, represented by any suitable network interfaces to facilitate communication via the various networks (including both internal and external networks) described herein. Such network interfaces may be inclusive of multiple wired and/or wireless interfaces (e.g., Wi-Fi, WiMax, 3G, 4G, 5G+, white space, 802.11x, satellite, Bluetooth, LTE, GSM/HSPA, CDMA/EVDO, DSRC, CAN, GPS, etc.). Other interfaces, may include physical ports (e.g., Ethernet, USB, HDMI, etc.), interfaces for wired and wireless internal subsystems, and the like. Similarly, each of the PSAP 102, the communication engine 104, the cluster engine 106, the server 120, cloud services 122, and the network element 124 can also include suitable interfaces for receiving, transmitting, and/or otherwise communicating data or information in a network environment.

The PSAP 102, the communication engine 104, the cluster engine 106, the data receiving engine 202, the text analysis engine 204, the geographical analysis engine 206, the temporal analysis engine 208, the patterns and correlation engine 210, the cluster creation engine 212, the auto message generation engine 214, the server 120, cloud services 122, and the network element 124 and other associated or integrated components can include one or more memory elements for storing information to be used in achieving operations associated with the creation of an event cluster, as outlined herein. These devices may further keep information in any suitable memory element (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in the system could be provided in any database, register, table, cache, queue, control list, or storage structure, based on particular needs and implementations, all of which could be referenced in any suitable timeframe. Any of the memory or storage options discussed herein should be construed as being encompassed within the broad term ‘memory element’ as used herein in this Specification.

In example embodiments, the operations for enabling the creation of an event cluster, outlined herein, may be implemented by logic encoded in one or more tangible media, which may be inclusive of non-transitory media (e.g., embedded logic provided in an ASIC, digital signal processor (DSP) instructions, software potentially inclusive of object code and source code to be executed by a processor or other similar machine, etc.). In some of these instances, one or more memory elements can store data used for the operations described herein. This includes the memory elements being able to store software, logic, code, or processor instructions that are executed to carry out the creation of an event cluster described in this Specification. Regarding a physical implementation of the PSAP 102, the communication engine 104, the cluster engine 106, the data receiving engine 202, the text analysis engine 204, the geographical analysis engine 206, the temporal analysis engine 208, the patterns and correlation engine 210, the cluster creation engine 212, the auto message generation engine 214, the server 120, cloud services 122, and the network element 124 and their associated components, any suitable permutation may be applied based on particular needs and requirements.

Note that with the examples provided herein, interaction may be described in terms of one, two, three, or more elements. However, this has been done for purposes of clarity and example only. In certain cases, it may be easier to describe one or more of the functionalities by only referencing a limited number of elements. It should be appreciated that the system, apparatus, and a method to enable the creation of an event cluster and their teachings are readily scalable and can accommodate a large number of components, as well as more complicated/sophisticated arrangements and configurations. Accordingly, the examples provided should not limit the scope or inhibit the broad teachings of the system, apparatus, and method to enable the creation of an event cluster and as potentially applied to a myriad of other architectures.

It is also important to note that the operations in the preceding flow diagrams (i.e., FIGS. 8-13) illustrate only some of the possible correlating scenarios and patterns that may be executed, some of these operations may be deleted or removed where appropriate, or these operations may be modified or changed considerably without departing from the scope of the present disclosure. In addition, the timing of these operations may be altered considerably. The preceding operational flows have been offered for purposes of example and discussion. Substantial flexibility is provided in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although the system and method have been illustrated with reference to particular elements and operations, these elements and operations may be replaced by any suitable architecture, protocols, and/or processes that achieve the intended functionality of the system and method.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
receiving a communication related to an event;
creating a cluster for the event if the cluster for the event has not already been created, wherein the cluster is associated with a specific public safety answering point (PSAP) operator at a PSAP;
adding the communication to the cluster; and
making the communication available to the specific PSAP operator.

2. The method of claim 1, wherein determining that the cluster should be created is performed by, a large language model, a computer model, or machine learning.

3. The method of claim 1, wherein the communication is a first communication received related to the event.

4. The method of claim 1, wherein data from a specific electronic device does not indicate the cluster should be created, however, when the data from the specific electronic device is combined with data from one or more other electronic devices, the data from the specific electronic device and the data from the one or more other electronic devices indicates the cluster should be created.

5. The method of claim 1, wherein the received communication is from a vehicle IoT device.

6. The method of claim 1, wherein the communication is received by the PSAP and sent to a general queue that includes all emergency related communications received by the PSAP.

7. The method of claim 6, further comprising:
in response to creating the cluster for the event, creating an auto message, wherein the auto message is sent to a user in response to the user sending a new communication reagrding the event in the cluster.

8. A system, comprising:
memory;
at least one processor; and
a cluster engine configured to:
analyze a communication to a public safety answering point (PSAP), wherein the communication is related to an event;
if a cluster for the event has not already been created, create the cluster for the event wherein the cluster is associated with a specific PSAP operator at the PSAP; and
send the communication to the specific PSAP operator.

9. The system of claim 8, wherein determining that the cluster should be created is performed by a large language model, a computer model, or machine learning.

10. The system of claim 8, wherein the cluster engine intercepts the communication before it reaches the PSAP.

11. The system of claim 8, wherein the cluster engine analyzes communications in a common queue at the PSAP that includes all emergency communications sent to the PSAP.

12. The system of claim 8, wherein in response to creating the cluster for the event, the cluster engine also creates an auto message, wherein the auto message is sent to a user in response to the user sending a new communication reagrding the event in the cluster.

13. The system of claim 8, wherein the communication is a first communication received related to the event.

14. The system of claim 8, wherein the communication is from a vehicle IoT device.

15. A method, comprising:
receiving, at a cluster engine, a communication to a public safety answering point (PSAP);
analyzing the communication to determine an event related to the communication;
if a cluster for the event has not already been created, creating the cluster for the event wherein the cluster is associated with a specific PSAP operator at the PSAP;
adding the communication to the cluster; and
making the communication available to the specific PSAP operator.

16. The method of claim 15, wherein the communication is analyzed to determine the event related to the communication using a computer model or machine learning.

17. The method of claim 15, wherein the communication is analyzed to determine the event related to the communication using natural language processing (NLP), clustering algorithms, geographical information systems (GIS), temporal analysis, and/or knowledge graphs.

18. The method of claim 17, wherein the communication is a first communication received related to the event.

19. The method of claim 15, wherein parameters of the cluster are changed by the specific PSAP operator.

20. The method of claim 15, wherein in response to creating the cluster for the event, the cluster engine also creates an auto message, wherein the auto message is sent to a user in response to the user sending a new communication reagrding the event in the cluster.
